(19) United States
(12) Patent Application Publication
(10) Pub. No.: US 2026/0113254 A1
(43) Pub. Date: Apr. 23, 2026

(54) SIGNALING KEY PERFORMANCE INDICATORS IN WIRELESS COMMUNICATIONS SYSTEMS

(71) Applicant: QUALCOMM Incorporated, San Diego, CA (US)

(72) Inventors: Rajeev KUMAR, San Diego, CA (US); Sherif ELAZZOUNI, San Diego, CA (US); Ozcan OZTURK, San Diego, CA (US); Gavin Bernard HORN, La Jolla, CA (US)

(21) Appl. No.: 18/923,536

(22) Filed: Oct. 22, 2024

(51) Int. Cl. H04L 41/5009; H04L 41/16; H04W 24/02; H04W 24/08

(52) U.S. Cl. CPC H04L 41/5009; H04L 41/16; H04W 24/02; H04W 24/08

(57) ABSTRACT

Methods, systems, and devices for wireless communications are described. A user equipment (UE) may receive a request to report a set of key performance indicators (KPIs) associated with one or more artificial intelligence (AI) functions operated by the UE. In response to receiving the request, the UE may determine the KPIs. In some examples, in response to determining the KPIs, the UE may transmit a report including an indication of the KPIs to one or more network functions, where the one or more network functions may utilize such KPIs to adjust one or more parameters at the UE, adjust the AI functions operated at the UE, or both. Accordingly, the UE may receive management information from the one or more network functions indicating the adjustment to the one or more parameters at the UE, the adjustment to the AI functions operated by the UE, or both.

### FIELD OF TECHNOLOGY

The following relates to wireless communications, including signaling key performance indicators in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more first control signals requesting the UE to report a set of key performance indicators (KPIs), where the set of KPIs are associated with one or more artificial intelligence (AI) functions operated at the UE, determining the set of KPIs based on receiving the one or more first control signals, and transmitting one or more reports including the set of KPIs based on determining the set of KPIs and on satisfaction of one or more reporting conditions associated with the set of KPIs.

A UE for wireless communications is described. The UE may include one or more memories storing processor executable code, and one or more processors coupled with the one or more memories. The one or more processors may individually or collectively be operable to execute the code to cause the UE to receive one or more first control signals requesting the UE to report a set of KPIs, where the set of KPIs are associated with one or more artificial intelligence functions operated at the UE, determine the set of KPIs based on receiving the one or more first control signals, and transmit one or more reports including the set of KPIs based on determining the set of KPIs and on satisfaction of one or more reporting conditions associated with the set of KPIs.

Another UE for wireless communications is described. The UE may include means for receiving one or more first control signals requesting the UE to report a set of KPIs, where the set of KPIs are associated with one or more artificial intelligence functions operated at the UE, means for determining the set of KPIs based on receiving the one or more first control signals, and means for transmitting one or more reports including the set of KPIs based on determining the set of KPIs and on satisfaction of one or more reporting conditions associated with the set of KPIs.

A non-transitory computer-readable medium storing code for wireless communications is described. The code may include instructions executable by one or more processors to receive one or more first control signals requesting the UE to report a set of KPIs, where the set of KPIs are associated with one or more artificial intelligence functions operated at the UE, determine the set of KPIs based on receiving the one or more first control signals, and transmit one or more reports including the set of KPIs based on determining the set of KPIs and on satisfaction of one or more reporting conditions associated with the set of KPIs.

In some examples of the method, UEs, and non-transitory computer-readable medium described herein, receiving the one or more first control signals may include operations, features, means, or instructions for receiving a respective control signal from a set of multiple network functions, where each respective control signal requests the UE to report at least one KPI of the set of KPIs, and where each network function of the set of multiple network functions may be associated with a respective protocol layer of a set of multiple protocol layers.

In some examples of the method, UEs, and non-transitory computer-readable medium described herein, transmitting the one or more reports may include operations, features, means, or instructions for transmitting a respective report to each network function of the set of multiple network functions, where each respective report includes at least one KPI of the set of KPIs, and where each respective report corresponds to a same protocol layer as an associated network function of the set of multiple network functions.

In some examples of the method, UEs, and non-transitory computer-readable medium described herein, receiving the one or more first control signals may include operations, features, means, or instructions for receiving a single control signal from a first network function, where the single control signal requests the UE to report the set of KPIs, and where the first network function may be associated with a first protocol layer of a set of multiple protocol layers.

In some examples of the method, UEs, and non-transitory computer-readable medium described herein, transmitting the one or more reports may include operations, features, means, or instructions for transmitting a single report including the set of KPIs, where each KPI of the set of KPIs may be associated with a respective protocol layer of the set of multiple protocol layers.

Some examples of the method, UEs, and non-transitory computer-readable medium described herein may further include operations, features, means, or instructions for transmitting one or more availability messages indicating that the set of KPIs may have been determined, where transmitting the one or more reports may be based on transmitting the one or more availability messages.

In some examples of the method, UEs, and non-transitory computer-readable medium described herein, transmitting the one or more availability messages may include operations, features, means, or instructions for transmitting a respective availability message to each network function of a set of multiple network functions, where each respective availability message indicates that at least one KPI of the set of KPIs may have been determined, and where each network function of the set of multiple network functions may be associated with a respective protocol layer of a set of multiple protocol layers.

In some examples of the method, UEs, and non-transitory computer-readable medium described herein, transmitting the one or more availability messages may include operations, features, means, or instructions for transmitting a single availability message to a single network function, where the single availability message indicates that the set of KPIs may have been determined, where each KPI of the set of KPIs may be associated with a respective protocol layer of a set of multiple protocol layers, and where the single network function may be associated with a first protocol layer of the set of multiple protocol layers.

In some examples of the method, UEs, and non-transitory computer-readable medium described herein, the one or more availability messages include UE assistance information (UAI) messages.

Some examples of the method, UEs, and non-transitory computer-readable medium described herein may further include operations, features, means, or instructions for transmitting the one or more availability messages may be based on the satisfaction of the one or more reporting conditions associated with the set of KPIs.

Some examples of the method, UEs, and non-transitory computer-readable medium described herein may further include operations, features, means, or instructions for receiving one or more monitoring report requests indicating for the UE to transmit the one or more reports, where transmitting the one or more reports may be based on receiving the one or more monitoring report requests.

In some examples of the method, UEs, and non-transitory computer-readable medium described herein, receiving the one or more monitoring report requests may include operations, features, means, or instructions for receiving a respective monitoring report request from each network function of a set of multiple network functions, where each respective monitoring report request indicates for the UE to transmit at least one KPI of the set of KPIs, and where each network function of the set of multiple network functions may be associated with a respective protocol layer of a set of multiple protocol layers.

In some examples of the method, UEs, and non-transitory computer-readable medium described herein, receiving the one or more monitoring report requests may include operations, features, means, or instructions for receiving a single monitoring report request from a single network function, where the single monitoring report request indicates for the UE to transmit the set of KPIs, where each KPI of the set of KPIs may be associated with a respective protocol layer of a set of multiple protocol layers, and where the single network function may be associated with a first protocol layer of the set of multiple protocol layers.

Some examples of the method, UEs, and non-transitory computer-readable medium described herein may further include operations, features, means, or instructions for receiving one or more second control signals including respective management information associated with each AI function of the one or more AI functions operated at the UE, where each respective management information may be based on a respective KPI of the set of KPIs.

In some examples of the method, UEs, and non-transitory computer-readable medium described herein, receiving the one or more second control signals may include operations, features, means, or instructions for receiving a respective second control signal from each network function of a set of multiple network functions, where each respective second control signal includes the respective management information for at least one AI function of the one or more AI functions, and where each network function of the set of multiple network functions may be associated with a respective protocol layer of a set of multiple protocol layers.

In some examples of the method, UEs, and non-transitory computer-readable medium described herein, receiving the one or more second control signals may include operations, features, means, or instructions for receiving single second control signal from a first network function, where the single second control signal includes the respective management information associated with each AI function of the one or more AI functions operated at the UE, where each AI function of the one or more AI functions may be associated with a respective protocol layer of a set of multiple protocol layers, and where the first network function may be associated with a first protocol layer of the set of multiple protocol layers.

In some examples of the method, UEs, and non-transitory computer-readable medium described herein, the respective management information includes reconfiguration information for a respective AI function of the one or more AI functions, one or more timers associated with operating the respective AI function, one or more counters associated with operating the respective AI function, an indication of whether the one respective AI function may be activated or deactivated, an indication of performance metrics associated with the UE, or any combination thereof.

In some examples of the method, UEs, and non-transitory computer-readable medium described herein, the one or more reporting conditions include a quantity of duplicate data packets communicated at the UE satisfying a first threshold, a quantity of data packets received out of order at the UE satisfying a second threshold, a quantity of retransmitted data packets from the UE satisfying a third threshold, a quantity of discarded packets at the UE satisfying a fourth threshold, expiration of one or more timers associated with reporting the set of KPIs, one or more of the set of KPIs failing to satisfy a fifth threshold, a respective periodicity of each KPI of the set of KPIs, or any combination thereof.

In some examples of the method, UEs, and non-transitory computer-readable medium described herein, the one or more reports include minimization of drive test (MDT) messages and the one or more reports further include one or more measurement parameters associated with the one or more AI functions operated at the UE.

In some examples of the method, UEs, and non-transitory computer-readable medium described herein, the one or more reports include self-organizing network (SON) messages and the one or more reports further include one or more measurement parameters associated with the one or more AI functions operated at the UE.

A method for wireless communications by a first network function is described. The method may include outputting a first control signal requesting a UE to report a set of KPIs, where the set of KPIs are associated with one or more AI functions operated at the UE, obtaining a report including the set of KPIs based on outputting the first control signal and on satisfaction of one or more reporting conditions associated with the set of KPIs, and outputting a second control signal including respective management information for each AI function of the one or more AI functions operated at the UE, where each respective management information is based on a respective KPI of the set of KPIs.

A first network function for wireless communications is described. The first network function may include one or more memories storing processor executable code, and one or more processors coupled with the one or more memories. The one or more processors may individually or collectively be operable to execute the code to cause the first network function to output a first control signal requesting a UE to report a set of KPIs, where the set of KPIs are associated with one or more AI functions operated at the UE, obtain a report including the set of KPIs based on outputting the first control signal and on satisfaction of one or more reporting conditions associated with the set of KPIs, and output a second control signal including respective management information for each AI function of the one or more AI functions operated at the UE, where each respective management information is based on a respective KPI of the set of KPIs.

Another first network function for wireless communications is described. The first network function may include means for outputting a first control signal requesting a UE to report a set of KPIs, where the set of KPIs are associated with one or more AI functions operated at the UE, means for obtaining a report including the set of KPIs based on outputting the first control signal and on satisfaction of one or more reporting conditions associated with the set of KPIs, and means for outputting a second control signal including respective management information for each AI function of the one or more AI functions operated at the UE, where each respective management information is based on a respective KPI of the set of KPIs.

A non-transitory computer-readable medium storing code for wireless communications is described. The code may include instructions executable by one or more processors to output a first control signal requesting a UE to report a set of KPIs, where the set of KPIs are associated with one or more AI functions operated at the UE, obtain a report including the set of KPIs based on outputting the first control signal and on satisfaction of one or more reporting conditions associated with the set of KPIs, and output a second control signal including respective management information for each AI function of the one or more AI functions operated at the UE, where each respective management information is based on a respective KPI of the set of KPIs.

Some examples of the method, first network functions, and non-transitory computer-readable medium described herein may further include operations, features, means, or instructions for obtaining a third control signal from a second network function, where the third control signal includes an indication of one or more KPIs that the second network function requests for the UE to report, where the one or more KPIs may be associated with a same protocol layer as the second network function, and where the set of KPIs include the one or more KPIs.

Some examples of the method, first network functions, and non-transitory computer-readable medium described herein may further include operations, features, means, or instructions for outputting a fourth control signal to the second network function, where the fourth control signal requests the second network function to provide the indication of the one or more KPIs, and where obtaining the third control signal may be based on outputting the fourth control signal.

Some examples of the method, first network functions, and non-transitory computer-readable medium described herein may further include operations, features, means, or instructions for outputting a third control signal to a second network function based on obtaining the report, where the third control signal includes one or more KPIs of the set of KPIs that may be associated with a same protocol layer as the second network function.

Some examples of the method, first network functions, and non-transitory computer-readable medium described herein may further include operations, features, means, or instructions for obtaining a fourth control signal from the second network function based on outputting the third control signal, where the fourth control signal includes management information associated with the one or more KPIs, and where transmitting the second control signal may be based on obtaining the fourth control signal.

In some examples of the method, first network functions, and non-transitory computer-readable medium described herein, each respective management information includes reconfiguration information for a respective AI function, one or more timers associated with operating the respective AI function, one or more counters associated with operating the respective AI function, an indication of whether the respective AI function may be activated or deactivated, an indication of performance metrics associated with the UE, or any combination thereof.

In some examples of the method, first network functions, and non-transitory computer-readable medium described herein, the report includes a MDT message and the report further includes one or more measurement parameters associated with the one or more AI functions operated at the UE.

In some examples of the method, first network functions, and non-transitory computer-readable medium described herein, the report includes a SON message and the report further include one or more measurement parameters associated with the one or more AI functions operated at the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports signaling key performance indicators in wireless communications systems in accordance with one or more aspects of the present disclosure.

FIG. 2 shows an example of a network architecture that supports signaling key performance indicators in wireless communications systems in accordance with one or more aspects of the present disclosure.

FIG. 3 shows an example of a wireless communications system that supports signaling key performance indicators in wireless communications systems in accordance with one or more aspects of the present disclosure.

FIG. 4 shows an example of a process flow that supports signaling key performance indicators in wireless communications systems in accordance with one or more aspects of the present disclosure.

FIG. 5 shows an example of a process flow that supports signaling key performance indicators in wireless communications systems in accordance with one or more aspects of the present disclosure.

FIGS. 6 and 7 show block diagrams of devices that support signaling key performance indicators in wireless communications systems in accordance with one or more aspects of the present disclosure.

FIG. 8 shows a block diagram of a communications manager that supports signaling key performance indicators in wireless communications systems in accordance with one or more aspects of the present disclosure.

FIG. 9 shows a diagram of a system including a device that supports signaling key performance indicators in wireless communications systems in accordance with one or more aspects of the present disclosure.

FIGS. 10 and 11 show block diagrams of devices that support signaling key performance indicators in wireless communications systems in accordance with one or more aspects of the present disclosure.

FIG. 12 shows a block diagram of a communications manager that supports signaling key performance indicators in wireless communications systems in accordance with one or more aspects of the present disclosure.

FIG. 13 shows a diagram of a system including a device that supports signaling key performance indicators in wireless communications systems in accordance with one or more aspects of the present disclosure.

FIGS. 14 through 17 show flowcharts illustrating methods that support signaling key performance indicators in wireless communications systems in accordance with one or more aspects of the present disclosure.

### DETAILED DESCRIPTION

A user equipment (UE) and a network entity may operate according to one or more parameters (e.g., radio resource control (RRC) parameters, packet delay convergence (PDCP) parameters, timing parameters, latency parameters, threshold parameters, among other examples), where the UE and the network entity may utilize such parameters to facilitate communication for uplink communications, downlink communications, or both. In some cases, the network entity may indicate a range of values associated with each parameter of the one or more parameters, where the UE may utilize an artificial intelligence (AI) or machine learning (ML) function to calculate (e.g., determine) a respective parameter value based on the indicated range of values. However, in such cases, the network entity may be unaware of the parameter value selected by the UE, nor be aware of whether the calculated parameter value improves or degrades the communications between the UE and the network entity. That is, because the UE calculates the parameter value based on the indicated range, the parameter value may be transparent to the network entity. Accordingly, the network entity may be unable to refine the indicated range associated with each parameter, which may lead to reduced coordination between the UE and the network entity. Thus, techniques may be desired for the network entity to refine the range of values associated with each of the one or more parameters.

Various aspects of the present disclosure generally relate to techniques that support reporting a set of key performance indicators (KPIs) associated with the AI or ML functions operated at the UE, such that one or more network functions of the wireless communications system may utilize such KPIs to refine the range of values associated with each parameter, modify the AI or ML functions operated at the UE, or both. In some examples, the UE may receive, from a single network function (e.g., a centralized network function, among other examples), control signaling that requests for the UE to report a set of KPIs, where each KPI of the set of KPIs may be associated with a respective AI or ML function and may be associated with a respective protocol layer (e.g., RRC layer, PDCP layer, radio link control (RLC) layer, among other examples). In response to receiving the control signaling, the UE may determine (e.g., calculate, obtain, identify, measure) each KPI of the requested set of KPIs and report such KPIs to the single network function. Using the received KPIs, the single network function may transmit a management signal to the UE, which may modify the range of values of a respective parameter associated with each KPI of the set of KPIs, modify (e.g., activate or deactivate) the AI or ML functions associated with each KPI of the set of KPIs, or both.

In some other examples, the UE may receive a respective control signal from multiple network functions, where each control signal includes a request for one or more KPIs associated with a protocol layer operated by a respective network function. For example, the UE may receive an RRC control signal from a first network function that operates (e.g., controls) RRC layer protocols, where the first network function may request, via the RRC control signal, for the UE to report one or more KPIs associated with one or more AI or ML functions that are used by the UE to obtain RRC parameters. Based on receiving each control signal, the UE may determine each KPI requested by the multiple network functions. Based on determining each KPI, the UE may transmit a respective monitoring report to each network function of the multiple network functions, where each monitoring report may include the KPIs associated with the protocol layer operated by the respective network function. For example, the UE may transmit, to the first network function that operates the RRC protocol layer, the one or more KPIs that are associated with the one or more AI or ML functions used by the UE to obtain RRC parameters. As such, each network function may transmit a respective management signal to the UE, where each management signal may modify the range of values of a respective parameter associated the protocol layer operated by the network function based on the respective KPIs, modify (e.g., activate or deactivate) the AI or ML functions associated with the protocol layer operated by the network function, or both.

In this way, the UE may transmit one or more monitoring reports that include the set of KPIs to one or more network functions, such that the one or more network functions may monitor and adjust the range of values associated with each parameter based on the associated KPI. By implementing such techniques, the UE and the network functions may experience increased coordination, thereby enabling the network functions to maintain, or improve, the quality of communications at the UE, among other advantages.

Aspects of the disclosure are initially described in the context of wireless communications systems. Aspects of the disclosure are further described in the context of a network architecture and process flows. Aspects of the disclosure are further illustrated by and described with reference to apparatus diagrams, system diagrams, and flowcharts that relate to signaling KPIs in wireless communications systems.

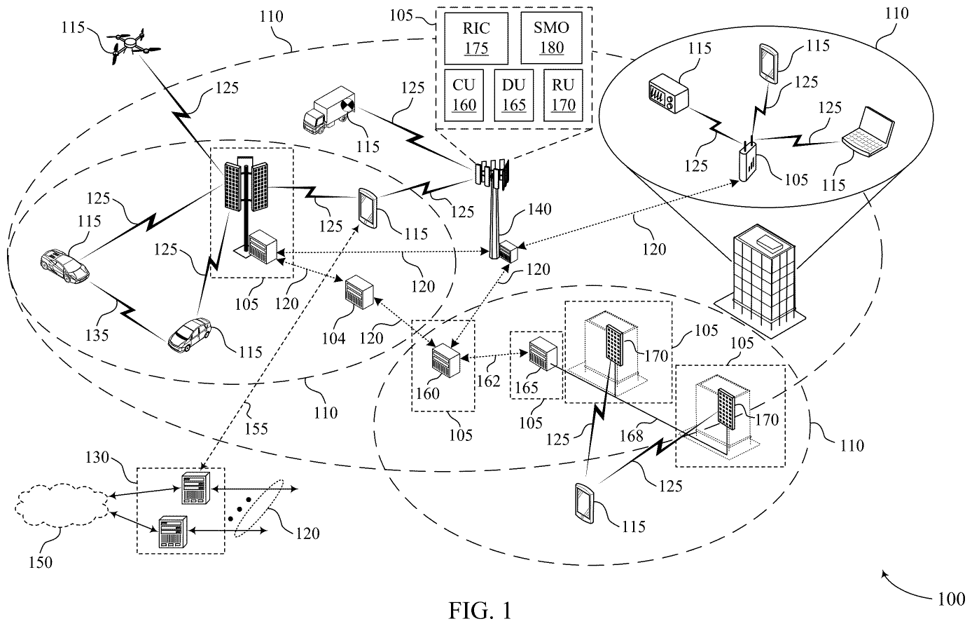

FIG. 1 shows an example of a wireless communications system 100 that supports signaling KPIs in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a fig. (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support signaling KPIs in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a network entity 105 (e.g., within a RAN) may perform one or more procedures to provide configurations for different protocol layers. For example, the network entity 105 may transmit RRC configurations to the UE 115, which may configure the UE 115 with different protocol layers information elements (e.g., PDCP, RLC, MAC, PHY). In some other examples, the network entity 105 may transmit one or more MAC control elements (MAC-CE) to activate or deactivate a configuration, indicate a selected configuration, indicate certain information (e.g., a transmission configuration indicator (TCI) state, a recommended communication bit rate, or other indications), update configurations (e.g., update of pathloss reference RS for a sounding reference signal (SRS) or physical uplink shared channel (PUSCH), among other examples), or send one or more commands (e.g., lower layer triggered mobility (LTM) activation).

In some cases, the UE 115 may utilize one or more procedures to request or provide information to the network entity 105. For example, the UE 115 may utilize RRC layer methods to transmit UE Assistance Information (UAI), which may be used by the UE 115 to request temporary UE capability restrictions, provide information (e.g., uplink traffic information), or other functions. Additionally, or alternatively, the UE 115 may transmit one or more measurement reports to indicate measurements on configured frequencies or communication cells. In some other examples, the UE 115 may use self-organizing network (SON) or minimization of drive test (MDT) reports to report measurements across different protocol layers for network improvement and organization.

Further, the UE 115 may use PDCP Status packet data units (PDUs) to inform a transmitting PDCP entity of the PDCP PDUs which were received or not received by a receiving PDCP entity. The UE 115 may also transmit RLC status PDUs to carry various RLC control information, such as acknowledgment (ACK) sequence numbers or indicate a location of a negative ACK (NACK) in a message (e.g., byte unit). In some examples, the UE 115 may use a MAC PDU (e.g., containing MAC-CE) to provide buffer status information to the network entity 105, and the UE 115 may use uplink control information (UCI) to transmit hybrid automatic repeat request (HARQ) ACKs (HARQ-ACKs), channel state information (CSI), scheduling requests (SR), among other examples.

In some cases, the UE 115 may utilize one or more AI or ML functions to perform various operations at the UE 115. For example, the UE 115 may utilize AI or ML functions during beam management procedures, which may include receiving, from the network entity 105, a reference signal monitoring configuration based on a CSI report configuration (e.g., CSI-ReportConfig IE), where the UE 115 may utilize the AI or ML functions to obtain the measurements of the reference signals. Further, the UE 115 may transmit one or more reference signal monitoring reports via CSI reporting, which may be reported periodically or based on one or more events.

In some other cases, the UE 115, the network entity 105, or both may utilize one or more AI or ML functions to perform positioning enhancement procedures. In some examples, the UE 115 may utilize one or more AI or ML functions to perform the positioning enhancement, where the UE may be configured with monitoring report configurations (e.g., via the LTE positioning protocol (LPP)). Accordingly, the UE may provide a monitoring report that is generated at least in part on the AI or ML functions to the network entity 105 via the LPP. In some examples, a location management function (LMF) of the wireless communications system 100 may provide the UE 115 with ground truth to assist in monitoring at the UE 115. In some examples, the LMF may operate one or more AI or ML functions to perform the positioning enhancement procedures, where the UE 115 and the network entity 105 (e.g., gNB) may be configured with a monitoring report configuration (e.g., via LPP and NR positioning protocol a (NRPPa)). Accordingly, both the UE 115 and the network entity 105 may provide the monitoring report to the LMF via LPP and NRPPa protocols. In some examples, the network entity 105 (e.g., gNB) may operate one or more AI or ML functions. For example, the UE 115 may be configured to report location information (e.g., using RRC), where the UE 115 may provide location information (e.g., using LPP). Alternatively, the LMF can provide ground truth for monitoring at the network entity 105, or the network entity 105 can provide monitoring report to LMF. Accordingly, various entities within the wireless communications system 100 may operate AI or ML functions to perform various operations.

In some other cases, the UE 115 may utilize one or more AI or ML functions to select one or more parameters for communication. For example, the UE 115 and the network entity 105 may operate according to one or more parameters (e.g., RRC parameters, PDCP parameters, timing parameters, latency parameters, threshold parameters, among other examples), where the UE 115 and the network entity 105 may utilize such parameters to facilitate communication for uplink communications, downlink communications, or both. In some cases, the network entity 105 may indicate a range of values associated with each parameter of the one or more parameters, where the UE 115 may utilize an AI or ML function to calculate (e.g., determine) a respective parameter value based on the indicated range of values. However, in such cases, the network entity 105 may be unaware of the parameter value selected by the UE 115, nor be aware of whether the calculated parameter value improves or degrades the communications between the UE 115 and the network entity 105. That is, because the UE 115 calculates the parameter value based on the indicated range, the parameter value may be transparent to the network entity 105. Accordingly, the network entity 105 may be unable to refine the indicated range associated with each parameter, which may lead to reduced coordination between the UE 115 and the network entity 105. Thus, techniques may be desired for the network entity 105 to refine the range of values associated with each of the one or more parameters.

Various aspects of the present disclosure generally relate to techniques that support reporting a set of KPIs associated with the AI or ML functions operated at the UE 115, such that one or more network functions of the wireless communications system may utilize such KPIs to refine the range of values associated with each parameter, modify the AI or ML functions operated at the UE 115, or both. In some examples, the UE 115 may receive, from a single network function (e.g., a centralized network function, among other examples), control signaling that requests for the UE 115 to report a set of KPIs, where each KPI of the set of KPIs may be associated with a respective AI or ML function and may be associated with a respective protocol layer (e.g., RRC layer, PDCP layer, RLC layer, among other examples). In response to receiving the control signaling, the UE 115 may determine (e.g., calculate, obtain, identify, measure) each KPI of the requested set of KPIs and report such KPIs to the single network function. Using the received KPIs, the single network function may transmit a management signal to the UE 115, which may modify the range of values of a respective parameter associated with each KPI of the set of KPIs, modify (e.g., activate or deactivate) the AI or ML functions associated with each KPI of the set of KPIs, or both.

In some other examples, the UE 115 may receive a respective control signal from multiple network functions, where each control signal includes a request for one or more KPIs associated with a protocol layer operated by a respective network function. For example, the UE 115 may receive an RRC control signal from a first network function that operates (e.g., controls) RRC layer protocols, where the first network function may request, via the RRC control signal, for the UE 115 to report one or more KPIs associated with one or more AI or ML functions that are used by the UE 115 to obtain RRC parameters. Based on receiving each control signal, the UE 115 may determine each KPI requested by the multiple network functions. Based on determining each KPI, the UE 115 may transmit a respective monitoring report to each network function of the multiple network functions, where each monitoring report may include the KPIs associated with the protocol layer operated by the respective network function. For example, the UE 115 may transmit, to the first network function that operates the RRC protocol layer, the one or more KPIs that are associated with the one or more AI or ML functions used by the UE 115 to obtain RRC parameters. As such, each network function may transmit a respective management signal to the UE 115, where each management signal may modify the range of values of a respective parameter associated the protocol layer operated by the network function based on the respective KPIs, modify (e.g., activate or deactivate) the AI or ML functions associated with the protocol layer operated by the network function, or both.

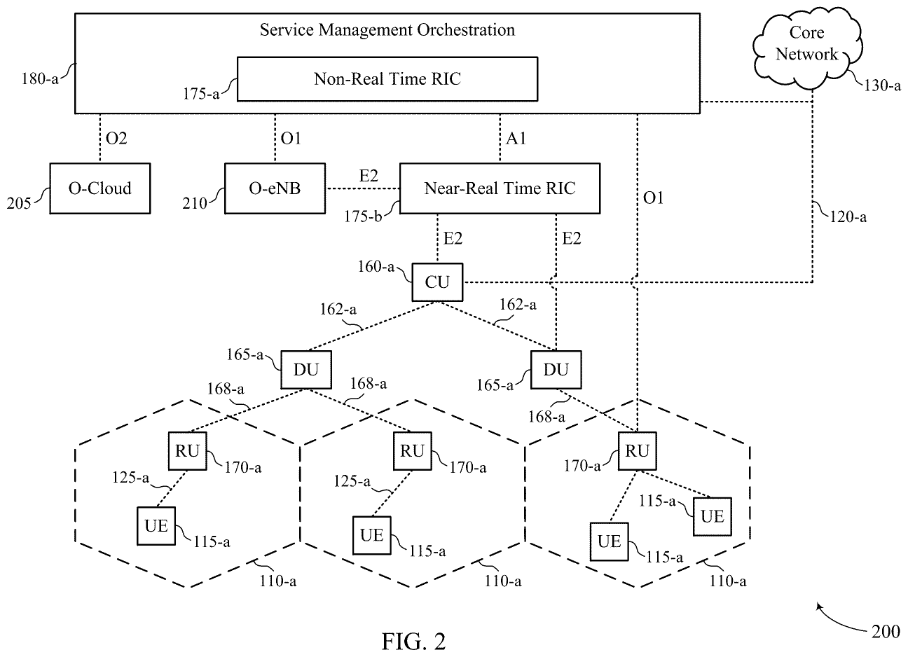

FIG. 2 shows an example of a network architecture 200 (e.g., a disaggregated base station architecture, a disaggregated RAN architecture) that supports signaling KPIs in wireless communications systems in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-cNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML functions to perform corrective actions through the SMO 180-a (e.g., reconfiguration via 01) or via generation of RAN management policies (e.g., AI policies).

In some cases, the UE 115-a may utilize one or more AI or ML functions to select one or more parameters for communication. For example, the UE 115-a and a network function (e.g., CU 160, DU 165, RU 170, and associated network functions) may operate according to one or more parameters (e.g., RRC parameters, PDCP parameters, timing parameters, latency parameters, threshold parameters, among other examples), where the UE 115-a and the network function may utilize such parameters to facilitate communication for uplink communications, downlink communications, or both. In some cases, the network function may indicate a range of values associated with each parameter of the one or more parameters, where the UE 115-a may utilize an AI or ML function to calculate (e.g., determine) a respective parameter value based on the indicated range of values. However, in such cases, the network function may be unaware of the parameter value selected by the UE 115-a, nor be aware of whether the calculated parameter value improves or degrades the communications between the UE 115-a and the network function. That is, because the UE 115-a calculates the parameter value based on the indicated range, the parameter value may be transparent to the network function. Accordingly, the network function may be unable to refine the indicated range associated with each parameter, which may lead to reduced coordination between the UE 115-a and the network function. Thus, techniques may be desired for the network function to refine the range of values associated with each of the one or more parameters.

Various aspects of the present disclosure generally relate to techniques that support reporting a set of KPIs associated with the AI or ML functions operated at the UE 115-a, such that one or more network functions of the wireless communications system may utilize such KPIs to refine the range of values associated with each parameter, modify the AI or ML functions operated at the UE 115-a, or both. In some examples, the UE 115-a may receive, from a single network function (e.g., a centralized network function, among other examples), control signaling that requests for the UE 115-a to report a set of KPIs, where each KPI of the set of KPIs may be associated with a respective AI or ML function and may be associated with a respective protocol layer (e.g., RRC layer, PDCP layer, RLC layer, among other examples). In response to receiving the control signaling, the UE 115-a may determine (e.g., calculate, obtain, identify, measure) each KPI of the requested set of KPIs and report such KPIs to the single network function. Using the received KPIs, the single network function may transmit a management signal to the UE 115-a, which may modify the range of values of a respective parameter associated with each KPI of the set of KPIs, modify (e.g., activate or deactivate) the AI or ML functions associated with each KPI of the set of KPIs, or both.

In some other examples, the UE 115-a may receive a respective control signal from multiple network functions, where each control signal includes a request for one or more KPIs associated with a protocol layer operated by a respective network function. For example, the UE 115-a may receive an RRC control signal from a first network function that operates (e.g., controls) RRC layer protocols, where the first network function may request, via the RRC control signal, for the UE 115-a to report one or more KPIs associated with one or more AI or ML functions that are used by the UE 115-a to obtain RRC parameters. Based on receiving each control signal, the UE 115-a may determine each KPI requested by the multiple network functions. Based on determining each KPI, the UE 115-a may transmit a respective monitoring report to each network function of the multiple network functions, where each monitoring report may include the KPIs associated with the protocol layer operated by the respective network function. For example, the UE 115-a may transmit, to the first network function that operates the RRC protocol layer, the one or more KPIs that are associated with the one or more AI or ML functions used by the UE 115-a to obtain RRC parameters. As such, each network function may transmit a respective management signal to the UE 115-a, where each management signal may modify the range of values of a respective parameter associated the protocol layer operated by the network function based on the respective KPIs, modify (e.g., activate or deactivate) the AI or ML functions associated with the protocol layer operated by the network function, or both.

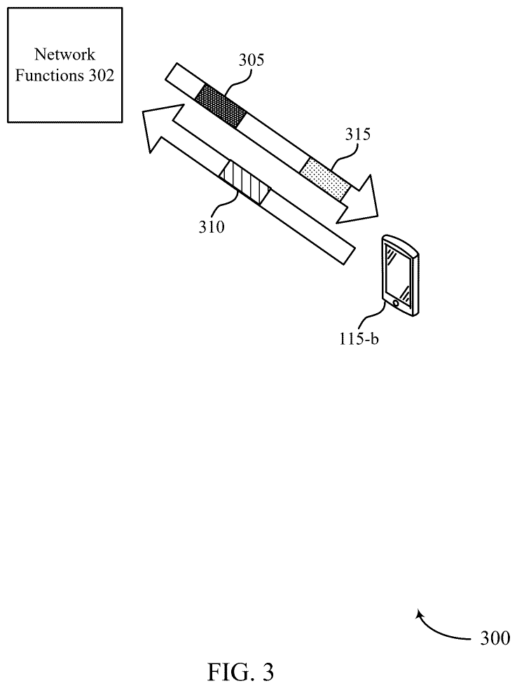

FIG. 3 shows an example of a wireless communications system 300 that supports signaling KPIs in wireless communications systems in accordance with one or more aspects of the present disclosure. Aspects of the wireless communications system 300 may implement, or be implemented by, aspects of the wireless communications system 100 and the network architecture 200, as described herein with reference to FIGS. 1 and 2. For example, the wireless communications system 300 may include a UE 115-b, which may be an example of UEs 115 described herein. The techniques described in the context of the wireless communications system 300 may enable the UE 115-b to report KPIs associated with one or more AI or ML functions at the UE, such that one or more network functions 302 may refine value ranges associated with parameters at the UE 115-b, modify the one more AI or ML functions at the UE 115-b, among other operations.

For example, the UE 115-b may utilize one or more AI or ML functions to select one or more parameters for communication. For example, the UE 115-b and the network entity 105 may operate according to one or more parameters (e.g., RRC parameters, PDCP parameters, timing parameters, latency parameters, threshold parameters, among other examples), where the UE 115-b and the network functions 302 (e.g., CU, DU, RU, and associated functions) may utilize such parameters to facilitate communication for uplink communications, downlink communications, or both. In some cases, the network functions 302 may indicate a range of values associated with each parameter of the one or more parameters, where the UE 115-b may utilize an AI or ML function to calculate (e.g., determine) a respective parameter value based on the indicated range of values.

For example, the UE 115-b may operate one or more first AI or ML functions to obtain one or more first parameters that are associated with a first protocol layer, and operate one or more second AI or ML functions to obtain one or more second parameters that are associated with a second protocol layer. As an illustrative example, the UE 115-b may operate a first AI or ML function to obtain one or more RRC parameters based on indicated ranges associated with the one or more RRC parameters. Accordingly, the first AI or ML function may be associated with (e.g., used for) the RRC layer.

However, in such cases, the network functions 302 may be unaware of the parameter value selected by the UE 115-b, nor be aware of whether the calculated parameter value improves or degrades the communications between the UE 115-b and the network functions 302. That is, because the UE 115-b calculates the parameter value based on the indicated range, the parameter value may be transparent to the network functions 302. Accordingly, the network functions 302 may be unable to refine the indicated range associated with each parameter, which may lead to reduced coordination between the UE 115-b and the network functions 302. Thus, techniques may be desired for the network functions 302 to refine the range of values associated with each of the one or more parameters.

In accordance with the techniques described herein, the UE 115-b and the network functions 302 may support various schemes for reporting a set of KPIs (e.g., one or more KPIs) associated with native AI or ML functions, where such AI or ML functions may be used by the UE 115-b to calculate the one or more parameters (e.g., RRC parameters, PDCP parameters, timing parameters, threshold parameters, among other examples). In this way, the network functions 302 may utilize such KPIs to refine the range of values associated with each parameter, modify the AI or ML functions operated at the UE 115-b, or both, thereby ensuring that the parameters selected by the UE 115-b improve wireless communications. Such techniques to report the KPIs may also improve inter-device coordination, and more specifically, improve coordination between the network functions 302 and the UE 115-b.

As described herein, the schemes utilized for reporting the set of KPIs may be based on the network function 302 (e.g., entity) that manages the protocol associated with the KPI or that manages the AI or ML function operated at the UE 115-b, based on whether a KPI is associated with (e.g., computed at) a single protocol layer or across multiple protocol layers, based on latency and performance metrics at the UE 115-b, or a combination thereof.

For example, the UE 115-b and the network functions 302 may support a centralized management scheme for reporting the one or more KPIs (e.g., via UAI), where the UE 115-b may transmit a single report to a single network function 302 (e.g., CU 160), where the single report includes KPIs from different protocol layers (e.g., for different AI or ML functions across protocol layers). Accordingly, the single network function 302 may manage the AI or ML functions at the UE 115-b. Such a centralized management scheme may be suitable for AI or ML functions at the UE 115-b that may accept higher management signaling delay and be suitable if the single network function 302 is able to use such KPIs to manage the AI or ML functions across the different protocol layers. Additionally, the centralized management scheme may reduce the duplication of KPIs reported for different protocol layers.

Alternatively, the UE 115-b and the network functions 302 may support a localized management scheme, where the UE 115-b may transmit multiple reports (e.g., a PDCP status PDU, a RLC status PDU, a MAC-CE, a UCI, a LPP, a NRPPa, among other examples), where each report indicates respective KPIs to respective network functions 302 according to the protocol layers associated with the KPIs. That is, each report may include KPIs that are associated with a single protocol layer (e.g., associated with one or more AI or ML functions of a protocol layer). The localized management scheme may be suitable for AI or ML functions that may not access higher management signaling delay and be suitable for network functions 302 that manage AI or ML functions associated with a single protocol layer.

Accordingly, in the example of the centralized management scheme, the UE 115-b may receive, from a single network function 302 (e.g., a CU 160, centralized network function, among other examples), control signaling 305 (e.g., RRC signaling) that requests for the UE 115-b to report a set of KPIs, where each KPI of the set of KPIs may be associated with a respective AI or ML function and may be associated with a respective protocol layer (e.g., RRC layer, PDCP layer, RLC layer, among other examples). In response to receiving the control signaling 305, the UE 115-b may determine (e.g., calculate, obtain, identify, measure) each KPI of the requested set of KPIs. Based on determining the set of KPIs, the UE 115 may transmit a monitoring report 310 to the single network function 302, where the monitoring report 310 indicates each determined KPI of the set of KPIs.

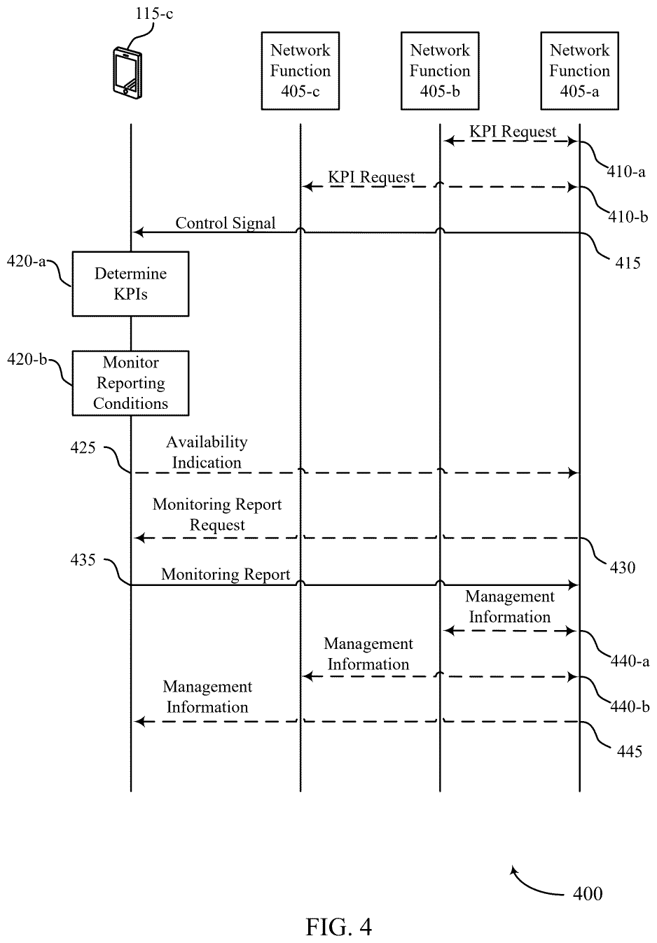

Using the received KPIs, the single network function 302 may transmit management information 315 to the UE 115-b. That management information 315 may indicate a modified range of values of a respective parameter (e.g., selection and indication of values for timers, counters, among other configured parameters), indicate modifications (e.g., reconfigurations, activations, deactivations) of one or more AI or ML functions associated with each KPI of the set of KPIs, or both. The centralized management scheme may be further described herein with reference to FIG. 4.

Alternatively, in the example of the localized management scheme, the UE 115-b may receive a respective control signal 305 from multiple network functions 302, where each control signal 305 includes a request for one or more KPIs associated with a protocol layer operated by a respective network function 302. For example, the UE 115-b may receive an RRC control signal from a first network function 302 that operates (e.g., controls) RRC layer protocols, where the first network function 302 may request, via the RRC control signal, for the UE 115-b to report one or more KPIs associated with one or more AI or ML functions that are used by the UE 115-b to obtain RRC parameters.

Based on receiving each control signal 305, the UE 115-b may determine each KPI requested by the multiple network functions. Accordingly, the UE 115-b may transmit a respective monitoring report 310 to each network function 302 of the multiple network functions 302, where each monitoring report 310 may include the KPIs associated with the protocol layer operated by the respective network function 302. For example, the UE 115-b may transmit, to the first network function 302 that operates the RRC protocol layer, a first monitoring report 310 that indicates one or more KPIs that are associated with the one or more AI or ML functions used by the UE 115-b to obtain RRC parameters.

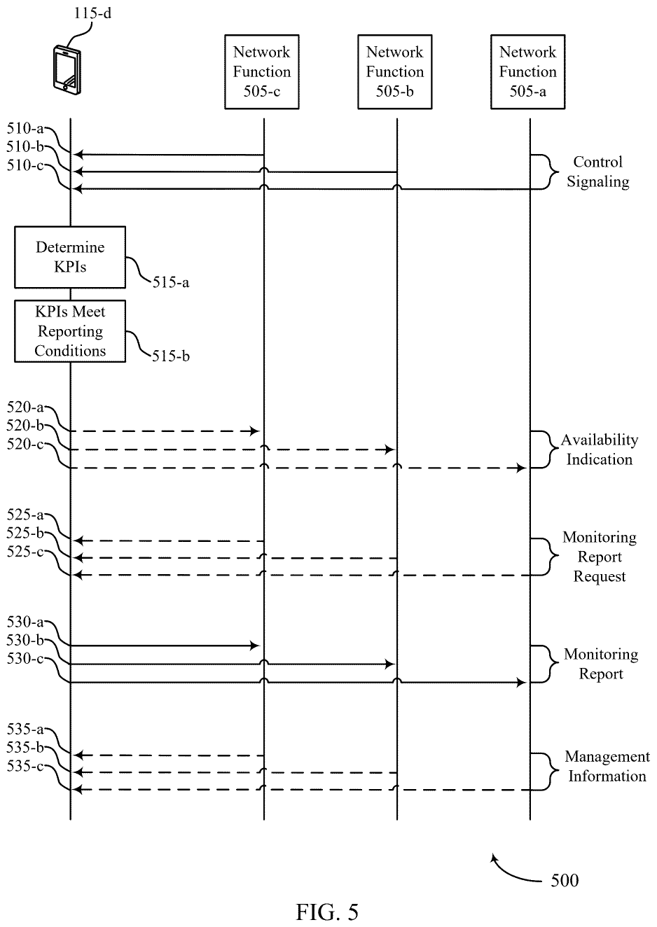

Using the respective KPIs, each network function 302 may transmit respective management information 315 to the UE 115-b. Each management information 315 may include a modified range of values of a respective parameter associated the protocol layer operated by the network function 302, indicate modifications (e.g., reconfigurations, activations, deactivations) of AI or ML functions associated with the protocol layer operated by the network function 302, or both. The localized management scheme may be further described herein with reference to FIG. 5.

FIG. 4 shows an example of a process flow 400 that supports signaling KPIs in wireless communications systems in accordance with one or more aspects of the present disclosure. Aspects of the process flow 400 may implement, or be implemented by, one or more aspects of the wireless communications system 100, the network architecture 200, and the wireless communications system 300. For example, the process flow 400 may include a UE 115-c, which may be an example of a UE 115 as described herein. Additionally, the process flow 400 may include a network function 405-a (e.g., CU 160, or other centralized network function), a network function 405-b (e.g., a DU 165), and a network function 405-c (e.g., a RU 170).

In the following description of the process flow 400, operations between the UE 115-c and the network functions 405 may occur in a different order or at different times than shown. Some operations may also be omitted from the process flow 400, and other operations may be added to the process flow 400. The techniques described in the context of the process flow 400 may enable the UE 115-c and the network function 405-a to support a centralized management of KPI reporting, as described herein with reference to FIG. 3.

For example, at 410-a, the network function 405-a may transmit control signaling (e.g., configuration request) to the network function 405-b, where the control signaling may request for the network function 405-b to provide an indication of which KPIs the UE 115-c is to report, where such KPIs may be associated with one or more first AI or ML functions operated at the UE 115-c. In such examples, the UE 115-c may utilize the one or more first AI or ML functions to obtain parameters for protocol layers that are managed by the network function 405-b. Accordingly, in response to receiving the control signaling, the network function 405-b may transmit an indication of a first set of KPIs for which the network function 405-b requests for the UE 115-c to report.

Similarly, at 410-b, the network function 405-a may transmit control signaling (e.g., configuration request) to the network function 405-c, where the control signaling may request for the network function 405-c to provide an indication of which KPIs the UE 115-c is to report, where such KPIs may be associated with one or more second AI or ML functions operated at the UE 115-c. In such examples, the UE 115-c may utilize the one or more second AI or ML functions to obtain parameters for protocol layers that are managed by the network function 405-c. Accordingly, in response to receiving the control signaling, the network function 405-b may transmit an indication of a second set of KPIs for which the network function 405-c requests for the UE 115-c to report.

At 415, the network function 405-a may transmit a control signal (e.g., the control signal 305, RRC message) requesting for the UE 115-c to report a set of KPIs. In such examples, the set of KPIs may include the first set of KPIs received from the network function 405-c, the second set of KPIs received from the network function 405-b, and a third set of KPIs that are requested by the network function 405-a. For example, the third set of KPIs may be associated with one or more third AI or ML functions at the UE 115-c, where the UE 115-c may utilize the one or more third AI or ML functions to obtain parameters for protocol layers that are managed by the network function 405-a.

At 420-a, the UE 115-c may determine (e.g., calculate, obtain, measure, identify) each KPI of the set of KPIs in response to receiving the control signal at 415. At 420-b, in response to determining each KPI of the set of KPIs, the UE 115-c may monitor one or more reporting conditions (e.g., reporting events) associated with reporting the set of KPIs to the network function 405-a at 435, for transmitting the availability indication at 425, or both. That is one or more reporting conditions may be defined per protocol layer, per AI or ML function, or both, such that the UE 115-c may report a first KPI of the set of KPIs based on satisfaction of a reporting condition defined for a protocol layer associated with the first KPI or defined for an AI or ML function associated with the first KPI. In some examples, the network functions 405-a, 405-b, and/or 405-c may provide the UE 115-c with respective sets of reporting conditions (e.g., via control signaling at 415 or via separate signaling) or such reporting conditions may be predefined.

In some examples, the reporting conditions may be one or more thresholds associated with the KPIs, such that if a first determined KPI is less than (e.g., falls below) an associated threshold, the UE 115-c may be triggered to report the first determined KPI. In some examples, the UE 115-c may be triggered to transmit a first KPI if a quantity of samples of a hysteresis of the first KPI that are below a threshold value. In some examples, the one or more reporting conditions may be the expiration of one or more prohibition timers (e.g., each timer associated with a respective KPI, AI or ML function, protocol layer), such that the UE 115-c may report, at 435, a first determined KPI in response to expiration of a first prohibition timer associated with the first determined KPI. In some examples, each protocol layer, each AI or ML function, or both may be associated with a respective periodicity for reporting KPIs. In such examples, the UE 115-c may report a first determined KPI according to a first periodicity defined for the protocol layer of the first determined KPI or defined for the AI or ML function associated with the first determined KPI.

In some other examples, the one or more reporting conditions may be associated with performance metrics at the UE 115-c (e.g., user plane performance metrics). For example, the UE 115-c may be triggered to report the set of KPIs based on a quantity of duplicate packets received at the UE 115-c being greater than a threshold quantity of duplicate packets. Similarly, the UE 115-c may be triggered to report the set of KPIs based on a quantity of duplicate packets transmitted from the UE 115-c being greater than a threshold quantity of duplicate packets. In some examples, the UE 115-c may be triggered to report the set of KPIs based on a quantity of PDCP packets received out of order at the UE 115-c being greater than a threshold quantity. In some other examples, the UE 115-c may be triggered to report the set of KPIs based on a quantity of retransmitted packets (e.g., PDCP or RLC packets) from the UE 115-c being greater than a threshold quantity. In some examples, the UE 115-c may be triggered to report the set of KPIs based on a quantity of discarded packets (e.g., PDCP or RLC packets) at the UE 115-c being greater than a threshold quantity.

In such examples (e.g., reporting conditions associated with performance metrics), the UE 115-c may monitor each performance metric (e.g., quantity of duplicate packets, quantity of out of order packets, among other examples) within a time window (e.g., configured by the network functions 405 or predefined). Accordingly, within the time window, the UE 115-c may obtain the average value of a performance metric, minimum value of a performance metric, maximum value of a performance metric, mean value of a performance metric, or a combination thereof and determine whether to report the set of KPIs. As an illustrative example, the time window may be set at 1 second, where, within the 1 second window, the UE 115-c may obtain the average, maximum, minimum, and mean values of the quantity of duplicate packets received at the UE 115-c. Accordingly, if any of the obtained values exceeds the threshold quantity of duplicate packets, the UE 115-c may be triggered to report the set of KPIs.

In some examples, at 425, the UE 115-c may transmit an availability indication to the network function 405-a, where the availability indication may indicate that the set of KPIs are ready to be reported. In some examples, the availability indication may be an example of an availability indicator for MDT procedures or SON procedures, which may be transmitted by the UE 115-c at any time. In some other examples, the UE 115-c may transmit the availability indication in response to satisfaction of one or more reporting conditions, as described at 420-b. Alternatively, the availability indication may be an example of UAI, where the UE 115-c may transmit the UAI to indicate that the set of KPIs are ready to be reported to the network function 405-a. The UE 115-c may transmit multiple availability indications to the network function 405-a, where each availability indication may indicate that one or more KPIs of the set of KPIs are ready to be reported. In such examples, the UE 115-c may transmit each availability indication in response to satisfaction of an associated reporting condition.

At 430, the network function 405-a may transmit a monitoring report request message, which may request for the UE 115-a to transmit determined set of KPIs. In some examples, the network function 405-a may transmit the monitoring report request message in response to receiving the availability indication at 425. Alternatively, the network function 405-a may transmit the monitoring report request message in response to satisfaction of one or more reporting conditions monitored by the network function 405-a (e.g., periodicity, timers, quantity of duplicate packets, among other examples).

At 435, the UE 115-c may transmit a monitoring report that indicates the set of KPIs determined at 420. In such examples, the UE 115-c may transmit the monitoring report in response to receiving the monitoring report request at 430. In some other examples, the UE 115-c may transmit the monitoring report in response to transmitting the availability indication at 425 (e.g., the monitoring report request is not transmitted at 430). In some examples, the UE 115-c may transmit the monitoring report at 435 in response to satisfaction of one or more reporting conditions at 420-b (e.g., the availability indication and the monitoring report request are not communicated).

In some examples, the monitoring report may be an example of a MDT report or a SON report. In such examples, if the UE 115-c transmits a MDT report to indicate the set of KPIs, the UE 115-c may also report one or more used parameters for the allowed AI native radio protocols via the MDT report. That is, the UE 115-c may report one or more measurement parameters associated with the AI or ML functions at the UE 115-c, report the parameters (e.g., RRC parameters, PDCP parameters, timing parameters, thresholds, among other examples) that are obtained by the UE 115-c using the AI or ML functions, report various inputs of the AI or ML functions, or a combination thereof. Similarly, if the UE 115-c transmits a SON report to indicate the set of KPIs, the UE 115-c may also report one or more used parameters for the allowed AI native radio protocols via the MDT report. That is, the UE 115-c may report one or more measurement parameters associated with the AI or ML functions at the UE 115-c, report the parameters (e.g., RRC parameters, PDCP parameters, timing parameters, thresholds, among other examples) that are obtained by the UE 115-c using the AI or ML functions, report various inputs of the AI or ML functions, or a combination.

In some examples, in response to receiving the monitoring report including the set of KPIs, the network function 405-a may communicate the first set of KPIs and the second set of KPIs to the network function 405-b and 405-c, respectively.

Accordingly, at 440-a, the network function 405-a may communicate the first set of KPIs (from the overall set of KPIs) to the network function 405-b. Accordingly, the network function 405-b may utilize the first set of KPIs to refine a range of values of parameters associated with the protocol layer managed by the network function 405-b. That is, the network function 405-b may utilize the first set of KPIs reported by the UE 115-c to generate first management information associated with the one or more first AI or ML functions at the UE 115-c (e.g., the AI or ML functions managed by the network function 405-b).

For example, based on the first set of KPIs, the network function 405-b may narrow down or widen the range of values for one or more timers, counters, or both associated with the protocol layer managed by the network function 405-b or select a value instead of a range of values for the one or more timers, counters, or both associated with the protocol layer managed by the network function 405-b. In some examples, the network function 405-b may determine to reconfigure, activate, or deactivate the one or more first AI or ML functions at the UE 115-c based on first set of KPIs. Additionally, in some examples, the network function 405-b may include, in the first management information, one or more performance metrics computed by the network function 405-b based on the first set of KPIs (e.g., UE throughput, latency, among other examples). In response to determining the first management information, the network function 405-b may indicate the first management information to the network function 405-a, such that the network function 405-a may relay the first management information to the UE 115-c at 450.

Similarly, at 440-b, the network function 405-a may communicate the second set of KPIs (from the overall set of KPIs) to the network function 405-c. Accordingly, the network function 405-c may utilize the second set of KPIs to refine a range of values of parameters associated with the protocol layer managed by the network function 405-c. That is, the network function 405-c may utilize the second set of KPIs reported by the UE 115-c to generate second management information associated with the one or more second AI or ML functions at the UE 115-c (e.g., the AI or ML functions managed by the network function 405-c).

For example, based on the second set of KPIs reported by the UE 115-c, the network function 405-c may narrow down or widen the range of values for one or more timers, counters, or both associated with the protocol layer managed by the network function 405-c or select a value instead of a range of values for the one or more timers, counters, or both associated with the protocol layer managed by the network function 405-c. In some examples, the network function 405-c may determine to reconfigure, activate, or deactivate the one or more second AI or ML functions at the UE 115-c based on second set of KPIs. Additionally, in some examples, the network function 405-c may include, in the second management information, one or more performance metrics computed by the network function 405-c based on the second set of KPIs (e.g., UE throughput, latency, among other examples). In response to determining the second management information, the network function 405-c may indicate the second management information to the network function 405-a, such that the network function 405-a may relay the second management information to the UE 115-c at 445.

At 445, the network function 405-a may transmit management information to the UE 115-c. In some examples, the management information may include the first management information received from the network function 405-b, the second management information received from the network function 405-c, and third management information associated with the protocol layer managed by the network function 405-a. For example, the network function 405-a may utilize the third set of KPIs to refine a range of values of parameters associated with the protocol layer managed by the network function 405-a. That is, the network function 405-a may utilize the third set of KPIs reported by the UE 115-c to generate the third management information associated with the one or more third AI or ML functions at the UE 115-c (e.g., the AI or ML functions managed by the network function 405-a). In some other examples, instead of communicating with the network functions 405-b and 405-c at 440, the network function 405-a may generate management information for each protocol layer or AI or ML function according to the set of KPIs.

Accordingly, in response to receiving the management information at 445, the UE 115-c may use the management information for operations. For example, the UE 115-c may reconfigure, activate, or deactivate various AI or ML function according to the management information, may input the refined range of values into the AI or ML functions to obtain the parameters, among other examples.

FIG. 5 shows an example of a process flow 500 that supports signaling KPIs in wireless communications systems in accordance with one or more aspects of the present disclosure. Aspects of the process flow 500 may implement, or be implemented by, one or more aspects of the wireless communications system 100, the network architecture 200, the wireless communications system 300, and the process flow 400, as described herein with reference to FIGS. 1 through 4. For example, the process flow 500 may include a UE 115-d (which may be an example of a UE 115). Additionally, the process flow 500 may include a network function 505-a (e.g., CU 160, centralized network function), a network function 505-b (e.g., DU 165), and a network function 505-c (e.g., RU 170).

In the following description of the process flow 500, operations between the UE 115-d and the network functions 505 may occur in a different order or at different times than shown. Some operations may also be omitted from the process flow 500, and other operations may be added to the process flow 500. The techniques described in the context of the process flow 500 may enable the UE 115-d and the network functions 505 to support a localized management scheme for KPI reporting, as described herein with reference to FIG. 3.

At 510, each network function 505 may transmit a respective control signal (e.g., the control signal 305, RRC message) requesting for the UE 115-d to report a respective set of KPIs. That is, in the localized management scheme for KPI reporting, the configuration for reporting performance KPIs may be provided via the respective protocol layer. As an illustrative example, for reporting KPIs associated with beam management, a network function 505 may transmit a CSI report configuration to request such KPIs, while for t-reassembly management, a network function 505 may transmit an RLC control PDU configuration. Accordingly, each protocol layer may independently provide configuration for AI or ML functions at that protocol layer.

As such, at 510-a, the network function 505-c may transmit a first control signal requesting for the UE 115-d to report a first set of KPIs, where the first set of KPIs may be associated with one or more protocol layers managed by the network function 505-c. Similarly, at 510-b, the network function 505-b may transmit a second control signal requesting for the UE 115-d to report a second set of KPIs, where the second set of KPIs may be associated with one or more protocol layers managed by the network function 505-b. Likewise, at 510-c, the network function 505-a may transmit a third control signal requesting for the UE 115-d to report a third set of KPIs, where the third set of KPIs may be associated with one or more protocol layers managed by the network function 505-a.

At 515-a, the UE 115-d may determine (e.g., calculate, obtain, measure, identify) each KPI of the first, second, and third sets of KPIs in response to receiving the control signals at 510. In response to determining each KPI and at 515-b, the UE 115-d may monitor one or more reporting conditions (e.g., reporting events) associated with reporting each set of KPIs to the network functions 505 at 530, for transmitting the availability indications at 520, or both. That is one or more reporting conditions may be defined per protocol layer, per AI or ML function, or both, such that the UE 115-d may report each set of KPIs to the respective network function 505 based on satisfaction of a reporting condition defined for the protocol layer managed by the respective network function 505. In some examples, the network functions 505-a, 505-b, and/or 505-c may provide the UE 115-d with respective sets of reporting conditions (e.g., via the control signals at 510 or via other signaling) or such reporting conditions may be predefined. Such reporting conditions may be further described herein with reference to operations at 420-b of FIG. 4.

In some examples, at 520, the UE 115-d may transmit a respective availability indication to each network function 505, where the availability indication may indicate that a respective set of KPIs is ready to be reported. In some examples, the availability indications may be examples of availability indicators for MDT procedures or SON procedures, which may be transmitted by the UE 115-d at any time. Alternatively, the availability indications may be examples of UAI, where the UE 115-d may transmit the UAIs to indicate that the respective sets of KPIs are ready to be reported. In some other examples, the UE 115-d may transmit the availability indications in response to satisfaction of one or more reporting conditions, as described at 515-b. That is, the UE 115-d may transmit each availability indication in response to satisfaction of an associated reporting condition.

Accordingly, at 520-a, the UE 115-d may transmit a first availability indication to the network function 505-c, where the first availability indication indicates that the first set of KPIs is ready to be reported. Similarly, at 520-b, the UE 115-d may transmit a second availability indication to the network function 505-b, where the second availability indication indicates that the second set of KPIs is ready to be reported. Likewise, at 520-c, the UE 115-d may transmit a third availability indication to the network function 505-a, where the third availability indication indicates that the third set of KPIs is ready to be reported.

At 525, each network function 505 may transmit a respective monitoring report request message, which may request for the UE 115-d to transmit a respective set of KPIs. In some examples, the network functions 505 may transmit the monitoring report request messages in response to receiving the availability indications at 520. Alternatively, the network functions 505 may transmit the monitoring report request messages in response to satisfaction of one or more reporting conditions monitored by the network functions 505 (e.g., periodicity, timers, quantity of duplicate packets, among other examples).

Accordingly, at 525-a, the network function 505-c may transmit a first monitoring report request message to request the first set of KPIs from the UE 115-d, which may be in response to receiving the first availability indication at 520-a or in response to satisfaction of one or more reporting conditions monitored by the network function 505-c. Similarly, at 525-b, the network function 505-b may transmit a send monitoring report request message to request the second set of KPIs from the UE 115-d, which may be in response to receiving the second availability indication at 520-b or in response to satisfaction of one or more reporting conditions monitored by the network function 505-b. Likewise at 525-c, at 525-a, the network function 505-a may transmit a third monitoring report request message to request the third set of KPIs from the UE 115-d, which may be in response to receiving the third availability indication at 520-c or in response to satisfaction of one or more reporting conditions monitored by the network function 505-a.

At 530, the UE 115-d may transmit a respective monitoring report to each network function 505. In such examples, the UE 115-d may transmit the monitoring reports in response to receiving the monitoring report requests at 525. In some other examples, the UE 115-d may transmit the monitoring reports in response to transmitting the availability indications at 520 (e.g., the monitoring report requests are not transmitted at 525). In some examples, the UE 115-d may transmit the monitoring reports at 530 in response to satisfaction of one or more reporting conditions at 515-b (e.g., the availability indications and the monitoring report requests are not communicated).

In some examples, the UE 115-d may transmit each monitoring report in a message associated with the relevant protocol layer (e.g., the configuring protocol layer), for example, using RRC signaling (e.g., UAI, SON or MDT reports), using PDCP PDUs, RLC PDUs, MAC-PDUs, UCI, LPP, among other examples.

Accordingly, at 530-a, the UE 115-d may transmit a first monitoring report indicating the first set of KPIs to the network function 505-c, where the first monitoring report may be carried in (e.g., or be) a message associated with the protocol layer managed by the network function 505-c. Likewise, at 530-b, the UE 115-d may transmit a second monitoring report indicating the second set of KPIs to the network function 505-b, where the second monitoring report may be carried in (e.g., or be) a message associated with the protocol layer managed by the network function 505-b. Likewise, at 530-c, the UE 115-d may transmit a third monitoring report indicating the third set of KPIs to the network function 505-a, where the third monitoring report may be carried in (e.g., or be) a message associated with the protocol layer managed by the network function 505-a.

In some examples, the UE 115-d may transmit multiple monitoring reports to a same network function 505-a, where each monitoring report may be carried in a message associated with a respective protocol layer managed by the same network function 505-a. For example, the network function 505-a may manage two protocol layers. Accordingly, the UE 115-d may transmit a first monitoring report indicate one or more KPIs of the third set of KPIs that are associated with a first protocol layer managed by the network function 505-a, while also transmitting a second monitoring report indicating one or more second KPIs of the third set of KPIs that are associated with a second protocol layer managed by the network function 505-a. In such examples, the first monitoring report may be carried in a message associated with the first protocol layer and the second monitoring report may be carried in a message associated with the second protocol layer.

At 535, each network function 505 may generate and indicate respective management information to the UE 115-d. That is, the relevant network function (e.g., node or protocol layer) may provide the management information, for example, using RRC signaling, PDCP control PDUs, RLC control PDUs, MAC-CEs, UCI, LPP, among other examples. Accordingly, at 440-a, the network function 505-a may communicate the first set of KPIs (from the overall set of KPIs) to the network function 505-b. Each network function 505 may generate the respective management information based on the respective KPIs provided by the UE 115-c at 530 in accordance with the techniques described herein at the operations of 440 and 445 of FIG. 4.

As such, at 535-a, the network function 505-c may generate and indicate first management information to the UE 115-d, where the first management information may be based on the first set of KPIs. Similarly, at 535-b, the network function 505-b may generate and indicate second management information to the UE 115-d, where the second management information may be based on the second set of KPIs. Likewise, at 535-c, the network function 505-a may generate and indicate third management information to the UE 115-d, where the third management information may be based on the third set of KPIs.

Accordingly, in response to receiving the management information at 535, the UE 115-d may use the management information for operations. For example, the UE 115-d may reconfigure, activate, or deactivate various AI or ML function according to the management information, may input the refined range of values into the AI or ML functions to obtain the parameters, among other examples.

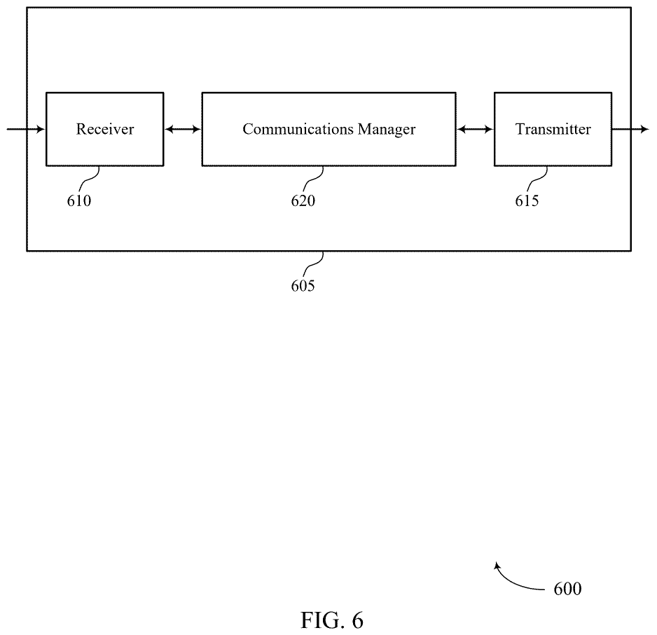

FIG. 6 shows a block diagram 600 of a device 605 that supports signaling KPIs in wireless communications systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling KPIs in wireless communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling KPIs in wireless communications systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of signaling KPIs in wireless communications systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving one or more first control signals requesting the UE to report a set of KPIs, where the set of KPIs are associated with one or more AI or ML functions operated at the UE. The communications manager 620 is capable of, configured to, or operable to support a means for determining the set of KPIs based on receiving the one or more first control signals. The communications manager 620 is capable of, configured to, or operable to support a means for transmitting one or more reports including the set of KPIs based on determining the set of KPIs and on satisfaction of one or more reporting conditions associated with the set of KPIs.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources, among other benefits.

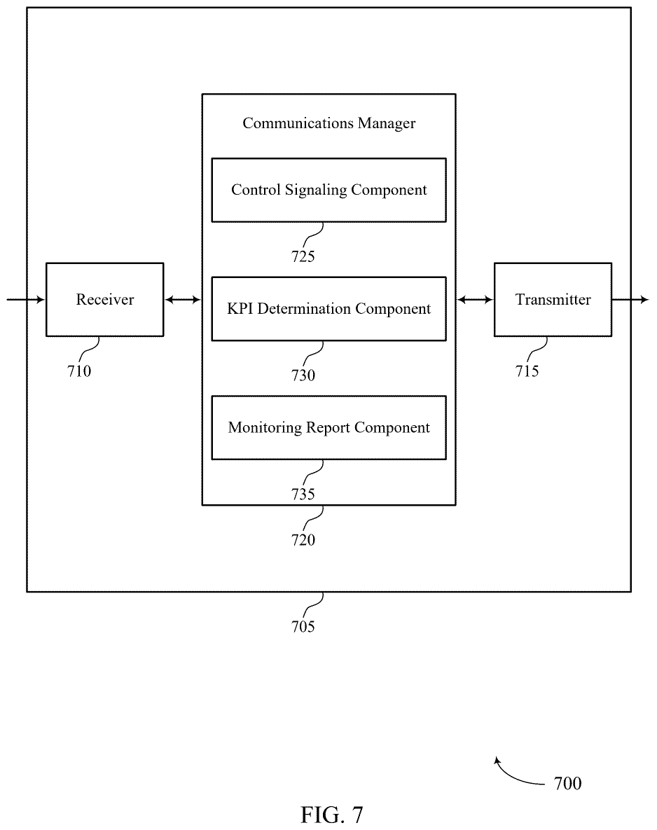

FIG. 7 shows a block diagram 700 of a device 705 that supports signaling KPIs in wireless communications systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling KPIs in wireless communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling KPIs in wireless communications systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling KPIs in wireless communications systems as described herein. For example, the communications manager 720 may include an control signaling component 725, a KPI determination component 730, a monitoring report component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control signaling component 725 is capable of, configured to, or operable to support a means for receiving one or more first control signals requesting the UE to report a set of KPIs, where the set of KPIs are associated with one or more AI or ML functions operated at the UE. The KPI determination component 730 is capable of, configured to, or operable to support a means for determining the set of KPIs based on receiving the one or more first control signals. The monitoring report component 735 is capable of, configured to, or operable to support a means for transmitting one or more reports including the set of KPIs based on determining the set of KPIs and on satisfaction of one or more reporting conditions associated with the set of KPIs.

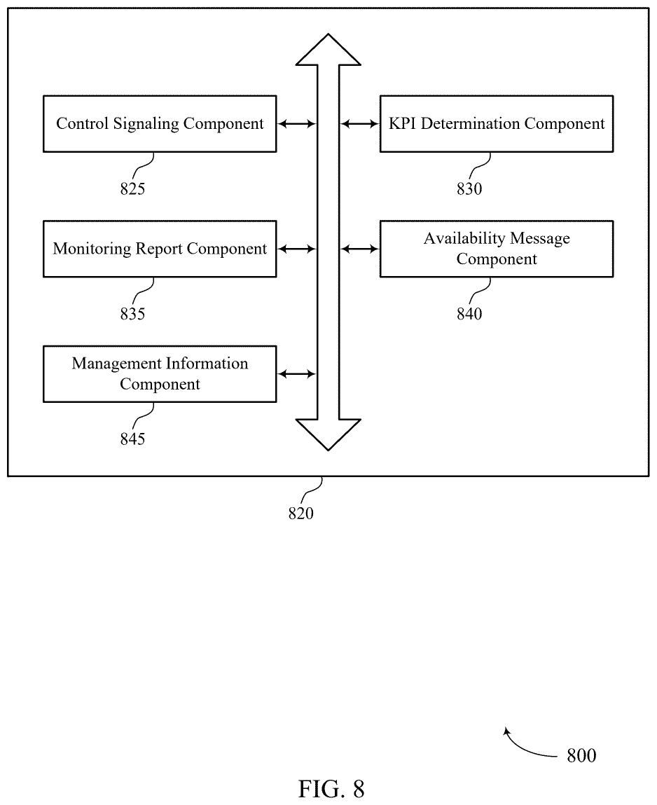

FIG. 8 shows a block diagram 800 of a communications manager 820 that supports signaling KPIs in wireless communications systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of signaling KPIs in wireless communications systems as described herein. For example, the communications manager 820 may include an control signaling component 825, a KPI determination component 830, a monitoring report component 835, an availability message component 840, a management information component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control signaling component 825 is capable of, configured to, or operable to support a means for receiving one or more first control signals requesting the UE to report a set of KPIs, where the set of KPIs are associated with one or more AI or ML functions operated at the UE. The KPI determination component 830 is capable of, configured to, or operable to support a means for determining the set of KPIs based on receiving the one or more first control signals. The monitoring report component 835 is capable of, configured to, or operable to support a means for transmitting one or more reports including the set of KPIs based on determining the set of KPIs and on satisfaction of one or more reporting conditions associated with the set of KPIs.

In some examples, to support receiving the one or more first control signals, the control signaling component 825 is capable of, configured to, or operable to support a means for receiving a respective control signal from a set of multiple network functions, where each respective control signal requests the UE to report at least one KPI of the set of KPIs, and where each network function of the set of multiple network functions is associated with a respective protocol layer of a set of multiple protocol layers.

In some examples, to support transmitting the one or more reports, the monitoring report component 835 is capable of, configured to, or operable to support a means for transmitting a respective report to each network function of the set of multiple network functions, where each respective report includes at least one KPI of the set of KPIs, and where each respective report corresponds to a same protocol layer as an associated network function of the set of multiple network functions.

In some examples, to support receiving the one or more first control signals, the control signaling component 825 is capable of, configured to, or operable to support a means for receiving a single control signal from a first network function, where the single control signal requests the UE to report the set of KPIs, and where the first network function is associated with a first protocol layer of a set of multiple protocol layers.

In some examples, to support transmitting the one or more reports, the monitoring report component 835 is capable of, configured to, or operable to support a means for transmitting a single report including the set of KPIs, where each KPI of the set of KPIs is associated with a respective protocol layer of the set of multiple protocol layers.

In some examples, the availability message component 840 is capable of, configured to, or operable to support a means for transmitting one or more availability messages indicating that the set of KPIs have been determined, where transmitting the one or more reports is based on transmitting the one or more availability messages.

In some examples, to support transmitting the one or more availability messages, the availability message component 840 is capable of, configured to, or operable to support a means for transmitting a respective availability message to each network function of a set of multiple network functions, where each respective availability message indicates that at least one KPI of the set of KPIs has been determined, and where each network function of the set of multiple network functions is associated with a respective protocol layer of a set of multiple protocol layers.

In some examples, to support transmitting the one or more availability messages, the availability message component 840 is capable of, configured to, or operable to support a means for transmitting a single availability message to a single network function, where the single availability message indicates that the set of KPIs have been determined, where each KPI of the set of KPIs is associated with a respective protocol layer of a set of multiple protocol layers, and where the single network function is associated with a first protocol layer of the set of multiple protocol layers.

In some examples, the one or more availability messages include UE assistance information messages.

In some examples, transmitting the one or more availability messages is based on the satisfaction of the one or more reporting conditions associated with the set of KPIs.

In some examples, the monitoring report component 835 is capable of, configured to, or operable to support a means for receiving one or more monitoring report requests indicating for the UE to transmit the one or more reports, where transmitting the one or more reports is based on receiving the one or more monitoring report requests.

In some examples, to support receiving the one or more monitoring report requests, the monitoring report component 835 is capable of, configured to, or operable to support a means for receiving a respective monitoring report request from each network function of a set of multiple network functions, where each respective monitoring report request indicates for the UE to transmit at least one KPI of the set of KPIs, and where each network function of the set of multiple network functions is associated with a respective protocol layer of a set of multiple protocol layers.

In some examples, to support receiving the one or more monitoring report requests, the monitoring report component 835 is capable of, configured to, or operable to support a means for receiving a single monitoring report request from a single network function, where the single monitoring report request indicates for the UE to transmit the set of KPIs, where each KPI of the set of KPIs is associated with a respective protocol layer of a set of multiple protocol layers, and where the single network function is associated with a first protocol layer of the set of multiple protocol layers.

In some examples, the management information component 845 is capable of, configured to, or operable to support a means for receiving one or more second control signals including respective management information associated with each artificial intelligence function of the one or more AI or ML functions operated at the UE, where each respective management information is based on a respective KPI of the set of KPIs.

In some examples, to support receiving the one or more second control signals, the management information component 845 is capable of, configured to, or operable to support a means for receiving a respective second control signal from each network function of a set of multiple network functions, where each respective second control signal includes the respective management information for at least one artificial intelligence function of the one or more AI or ML functions, and where each network function of the set of multiple network functions is associated with a respective protocol layer of a set of multiple protocol layers.

In some examples, to support receiving the one or more second control signals, the management information component 845 is capable of, configured to, or operable to support a means for receiving single second control signal from a first network function, where the single second control signal includes the respective management information associated with each artificial intelligence function of the one or more AI or ML functions operated at the UE, where each artificial intelligence function of the one or more AI or ML functions is associated with a respective protocol layer of a set of multiple protocol layers, and where the first network function is associated with a first protocol layer of the set of multiple protocol layers.

In some examples, the respective management information includes reconfiguration information for a respective artificial intelligence function of the one or more AI or ML functions, one or more timers associated with operating the respective artificial intelligence function, one or more counters associated with operating the respective artificial intelligence function, an indication of whether the one respective artificial intelligence function is activated or deactivated, an indication of performance metrics associated with the UE, or any combination thereof.

In some examples, the one or more reporting conditions include a quantity of duplicate data packets communicated at the UE satisfying a first threshold, a quantity of data packets received out of order at the UE satisfying a second threshold, a quantity of retransmitted data packets from the UE satisfying a third threshold, a quantity of discarded packets at the UE satisfying a fourth threshold, expiration of one or more timers associated with reporting the set of KPIs, one or more of the set of KPIs failing to satisfy a fifth threshold, a respective periodicity of each KPI of the set of KPIs, or any combination thereof.

In some examples, the one or more reports include MDT messages. In some examples, the one or more reports further include one or more measurement parameters associated with the one or more AI or ML functions operated at the UE.

In some examples, the one or more reports include SON messages. In some examples, the one or more reports further include one or more measurement parameters associated with the one or more AI or ML functions operated at the UE.

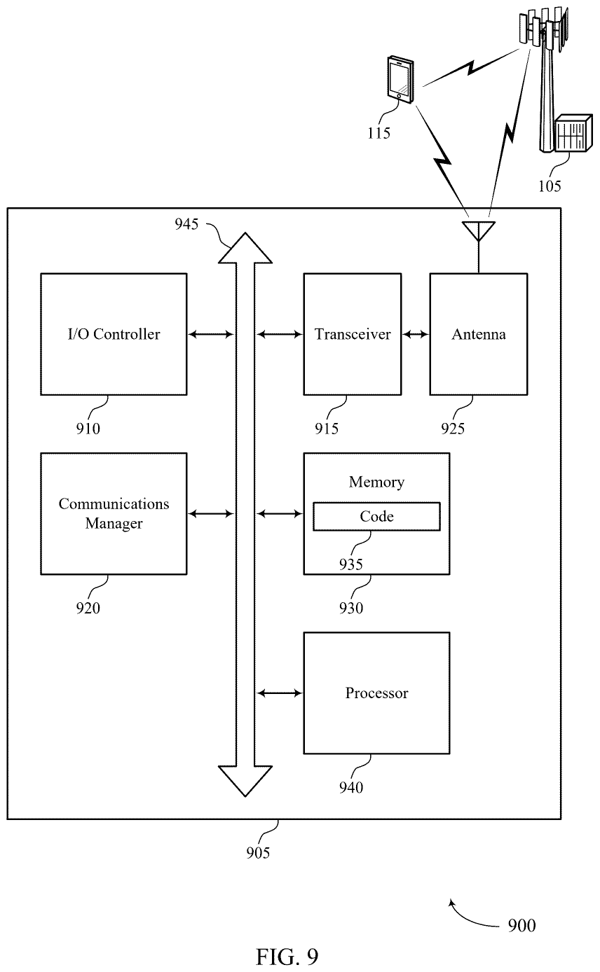

FIG. 9 shows a diagram of a system 900 including a device 905 that supports signaling KPIs in wireless communications systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting signaling KPIs in wireless communications systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving one or more first control signals requesting the UE to report a set of KPIs, where the set of KPIs are associated with one or more AI or ML functions operated at the UE. The communications manager 920 is capable of, configured to, or operable to support a means for determining the set of KPIs based on receiving the one or more first control signals. The communications manager 920 is capable of, configured to, or operable to support a means for transmitting one or more reports including the set of KPIs based on determining the set of KPIs and on satisfaction of one or more reporting conditions associated with the set of KPIs.

By including or configuring the communications manager 920 in accordance with examples as described herein, the device 905 may support techniques for more efficient utilization of communication resources, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of signaling KPIs in wireless communications systems as described herein, or the at least one processor 940 and the at least one memory 930 may be otherwise configured to, individually or collectively, perform or support such operations.

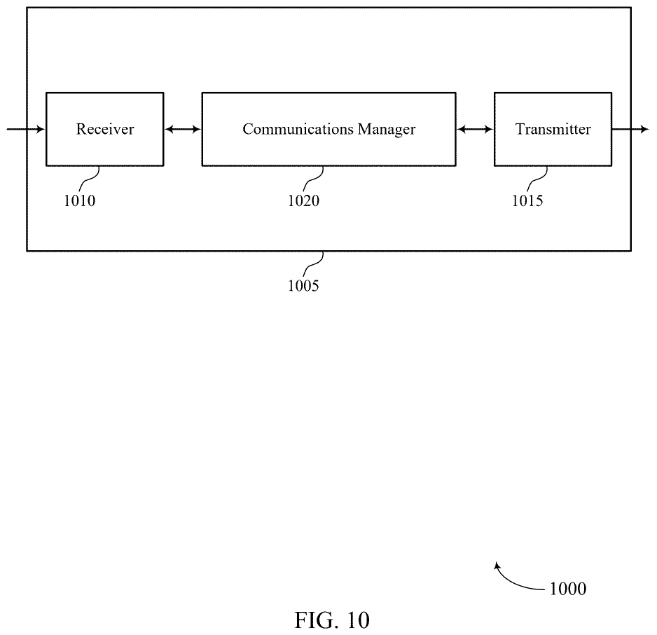

FIG. 10 shows a block diagram 1000 of a device 1005 that supports signaling KPIs in wireless communications systems in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of signaling KPIs in wireless communications systems as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a first control signal requesting a UE to report a set of KPIs, where the set of KPIs are associated with one or more AI or ML functions operated at the UE. The communications manager 1020 is capable of, configured to, or operable to support a means for obtaining a report including the set of KPIs based on outputting the first control signal and on satisfaction of one or more reporting conditions associated with the set of KPIs. The communications manager 1020 is capable of, configured to, or operable to support a means for outputting a second control signal including respective management information for each artificial intelligence function of the one or more AI or ML functions operated at the UE, where each respective management information is based on a respective KPI of the set of KPIs.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for may support techniques for more efficient utilization of communication resources, among other benefits.

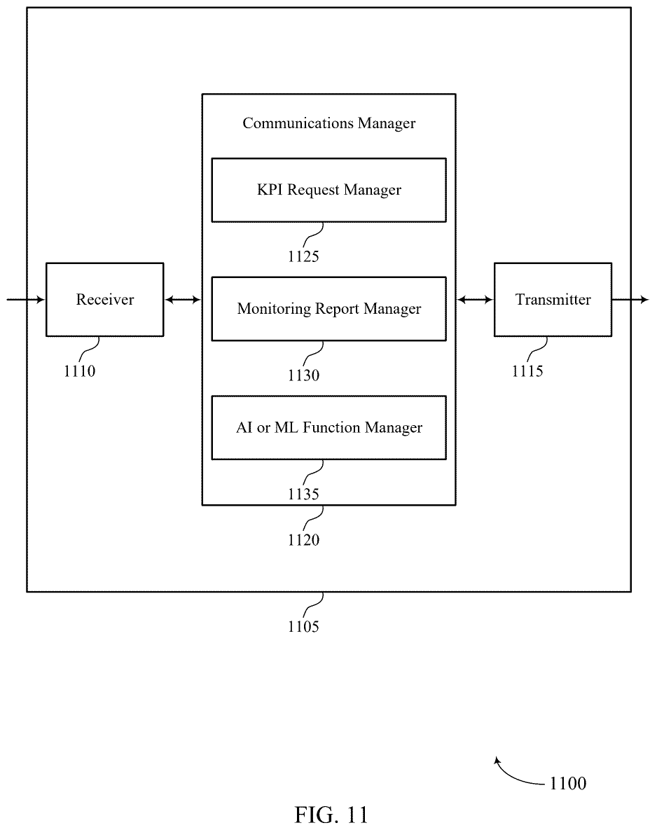

FIG. 11 shows a block diagram 1100 of a device 1105 that supports signaling KPIs in wireless communications systems in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of signaling KPIs in wireless communications systems as described herein. For example, the communications manager 1120 may include an KPI request manager 1125, a monitoring report manager 1130, a AI or ML function manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The KPI request manager 1125 is capable of, configured to, or operable to support a means for outputting a first control signal requesting a UE to report a set of KPIs, where the set of KPIs are associated with one or more AI or ML functions operated at the UE. The monitoring report manager 1130 is capable of, configured to, or operable to support a means for obtaining a report including the set of KPIs based on outputting the first control signal and on satisfaction of one or more reporting conditions associated with the set of KPIs. The AI or ML function manager 1135 is capable of, configured to, or operable to support a means for outputting a second control signal including respective management information for each artificial intelligence function of the one or more AI or ML functions operated at the UE, where each respective management information is based on a respective KPI of the set of KPIs.

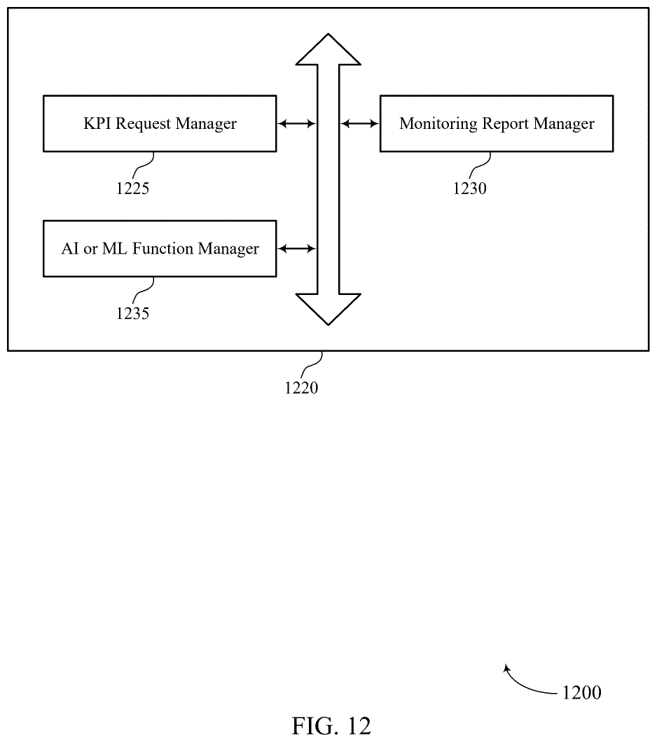

FIG. 12 shows a block diagram 1200 of a communications manager 1220 that supports signaling KPIs in wireless communications systems in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of signaling KPIs in wireless communications systems as described herein. For example, the communications manager 1220 may include an KPI request manager 1225, a monitoring report manager 1230, a AI or ML function manager 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The KPI request manager 1225 is capable of, configured to, or operable to support a means for outputting a first control signal requesting a UE to report a set of KPIs, where the set of KPIs are associated with one or more AI or ML functions operated at the UE. The monitoring report manager 1230 is capable of, configured to, or operable to support a means for obtaining a report including the set of KPIs based on outputting the first control signal and on satisfaction of one or more reporting conditions associated with the set of KPIs. The AI or ML function manager 1235 is capable of, configured to, or operable to support a means for outputting a second control signal including respective management information for each artificial intelligence function of the one or more AI or ML functions operated at the UE, where each respective management information is based on a respective KPI of the set of KPIs.

In some examples, the KPI request manager 1225 is capable of, configured to, or operable to support a means for obtaining a third control signal from a second network function, where the third control signal includes an indication of one or more KPIs that the second network function requests for the UE to report, where the one or more KPIs are associated with a same protocol layer as the second network function, and where the set of KPIs include the one or more KPIs.

In some examples, the KPI request manager 1225 is capable of, configured to, or operable to support a means for outputting a fourth control signal to the second network function, where the fourth control signal requests the second network function to provide the indication of the one or more KPIs, and where obtaining the third control signal is based on outputting the fourth control signal.

In some examples, the KPI request manager 1225 is capable of, configured to, or operable to support a means for outputting a third control signal to a second network function based on obtaining the report, where the third control signal includes one or more KPIs of the set of KPIs that are associated with a same protocol layer as the second network function.

In some examples, the AI or ML function manager 1235 is capable of, configured to, or operable to support a means for obtaining a fourth control signal from the second network function based on outputting the third control signal, where the fourth control signal includes management information associated with the one or more KPIs, and where transmitting the second control signal is based on obtaining the fourth control signal.

In some examples, each respective management information includes reconfiguration information for a respective artificial intelligence function, one or more timers associated with operating the respective artificial intelligence function, one or more counters associated with operating the respective artificial intelligence function, an indication of whether the respective artificial intelligence function is activated or deactivated, an indication of performance metrics associated with the UE, or any combination thereof.

In some examples, the report includes a MDT message. In some examples, the report further includes one or more measurement parameters associated with the one or more AI or ML functions operated at the UE.

In some examples, the report includes a SON message. In some examples, the report further includes one or more measurement parameters associated with the one or more AI or ML functions operated at the UE.

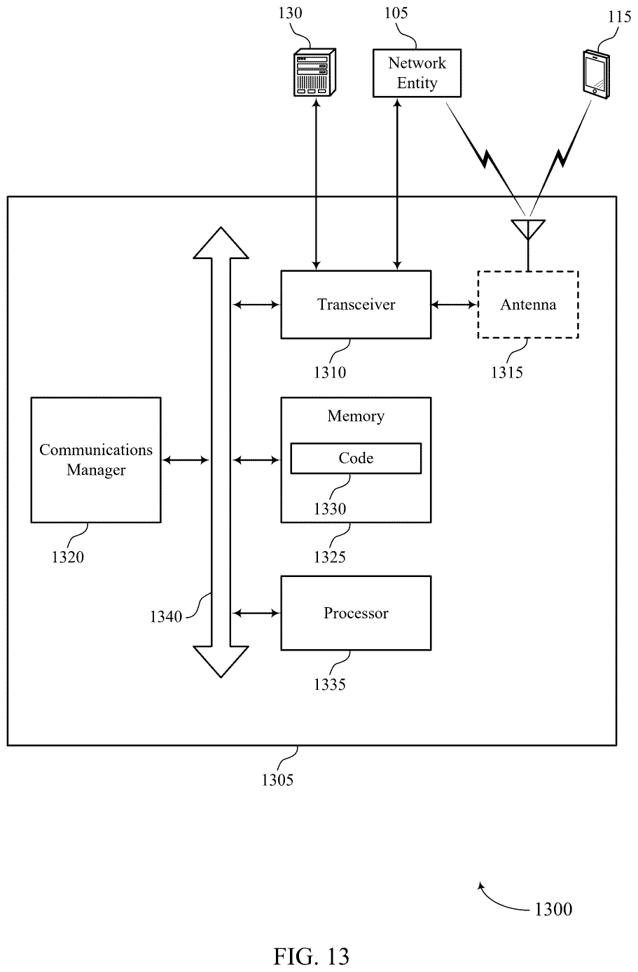

FIG. 13 shows a diagram of a system 1300 including a device 1305 that supports signaling KPIs in wireless communications systems in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting signaling KPIs in wireless communications systems). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a first control signal requesting a UE to report a set of KPIs, where the set of KPIs are associated with one or more AI or ML functions operated at the UE. The communications manager 1320 is capable of, configured to, or operable to support a means for obtaining a report including the set of KPIs based on outputting the first control signal and on satisfaction of one or more reporting conditions associated with the set of KPIs. The communications manager 1320 is capable of, configured to, or operable to support a means for outputting a second control signal including respective management information for each artificial intelligence function of the one or more AI or ML functions operated at the UE, where each respective management information is based on a respective KPI of the set of KPIs.

By including or configuring the communications manager 1320 in accordance with examples as described herein, the device 1305 may support techniques for communication reliability, reduced latency, and more efficient utilization of communication resources, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of signaling KPIs in wireless communications systems as described herein, or the at least one processor 1335 and the at least one memory 1325 may be otherwise configured to, individually or collectively, perform or support such operations.

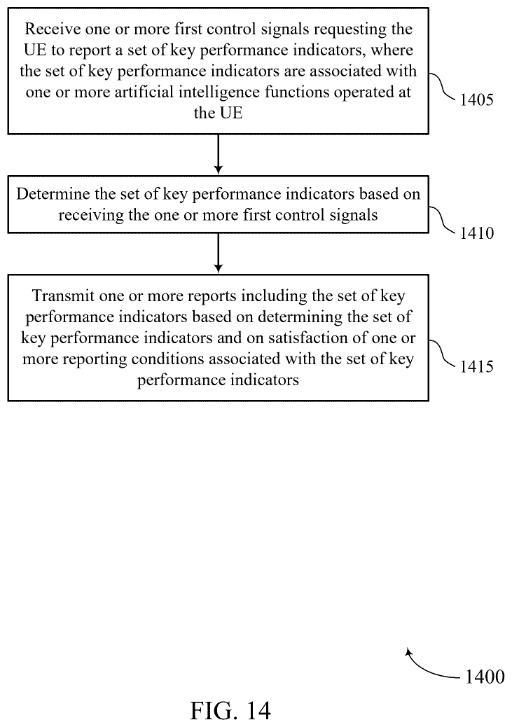

FIG. 14 shows a flowchart illustrating a method 1400 that supports signaling KPIs in wireless communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving one or more first control signals requesting the UE to report a set of KPIs, where the set of KPIs are associated with one or more AI or ML functions operated at the UE. The operations of 1405 may be performed in accordance with examples as disclosed herein. In some examples, aspects of the operations of 1405 may be performed by an control signaling component 825 as described with reference to FIG. 8.

At 1410, the method may include determining the set of KPIs based on receiving the one or more first control signals. The operations of 1410 may be performed in accordance with examples as disclosed herein. In some examples, aspects of the operations of 1410 may be performed by a KPI determination component 830 as described with reference to FIG. 8.

At 1415, the method may include transmitting one or more reports including the set of KPIs based on determining the set of KPIs and on satisfaction of one or more reporting conditions associated with the set of KPIs. The operations of 1415 may be performed in accordance with examples as disclosed herein. In some examples, aspects of the operations of 1415 may be performed by a monitoring report component 835 as described with reference to FIG. 8.

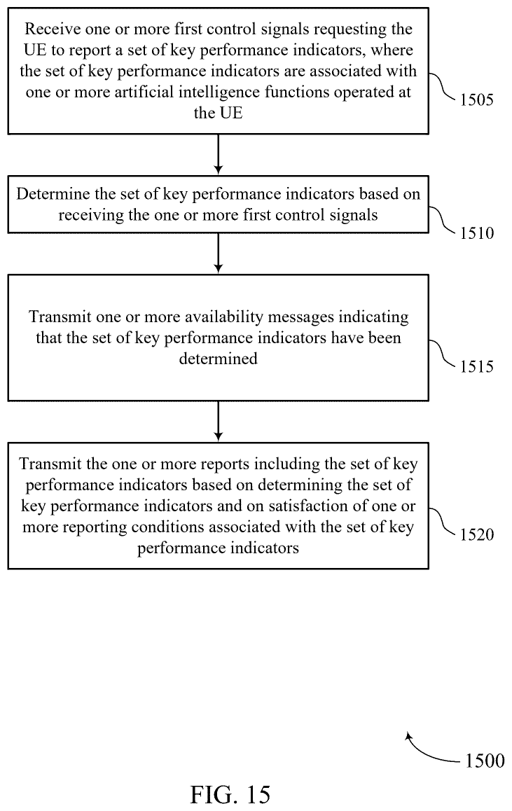

FIG. 15 shows a flowchart illustrating a method 1500 that supports signaling KPIs in wireless communications systems in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving one or more first control signals requesting the UE to report a set of KPIs, where the set of KPIs are associated with one or more AI or ML functions operated at the UE. The operations of 1505 may be performed in accordance with examples as disclosed herein. In some examples, aspects of the operations of 1505 may be performed by an control signaling component 825 as described with reference to FIG. 8.

At 1510, the method may include determining the set of KPIs based on receiving the one or more first control signals. The operations of 1510 may be performed in accordance with examples as disclosed herein. In some examples, aspects of the operations of 1510 may be performed by a KPI determination component 830 as described with reference to FIG. 8.

At 1515, the method may include transmitting one or more availability messages indicating that the set of KPIs have been determined. The operations of 1515 may be performed in accordance with examples as disclosed herein. In some examples, aspects of the operations of 1515 may be performed by an availability message component 840 as described with reference to FIG. 8.

At 1520, the method may include transmitting one or more reports including the set of KPIs based on determining the set of KPIs and on satisfaction of one or more reporting conditions associated with the set of KPIs. The operations of 1520 may be performed in accordance with examples as disclosed herein. In some examples, aspects of the operations of 1520 may be performed by a monitoring report component 835 as described with reference to FIG. 8.

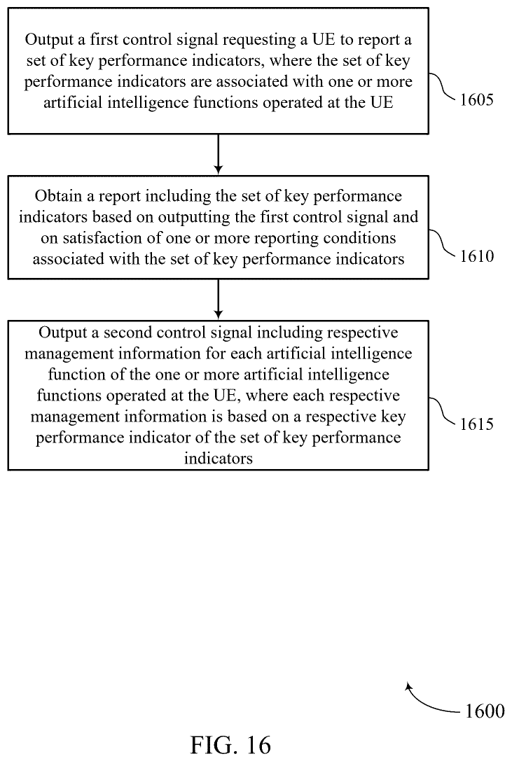

FIG. 16 shows a flowchart illustrating a method 1600 that supports signaling KPIs in wireless communications systems in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first control signal requesting a UE to report a set of KPIs, where the set of KPIs are associated with one or more AI or ML functions operated at the UE. The operations of 1605 may be performed in accordance with examples as disclosed herein. In some examples, aspects of the operations of 1605 may be performed by an KPI request manager 1225 as described with reference to FIG. 12.

At 1610, the method may include obtaining a report including the set of KPIs based on outputting the first control signal and on satisfaction of one or more reporting conditions associated with the set of KPIs. The operations of 1610 may be performed in accordance with examples as disclosed herein. In some examples, aspects of the operations of 1610 may be performed by a monitoring report manager 1230 as described with reference to FIG. 12.

At 1615, the method may include outputting a second control signal including respective management information for each artificial intelligence function of the one or more AI or ML functions operated at the UE, where each respective management information is based on a respective KPI of the set of KPIs. The operations of 1615 may be performed in accordance with examples as disclosed herein. In some examples, aspects of the operations of 1615 may be performed by a AI or ML function manager 1235 as described with reference to FIG. 12.

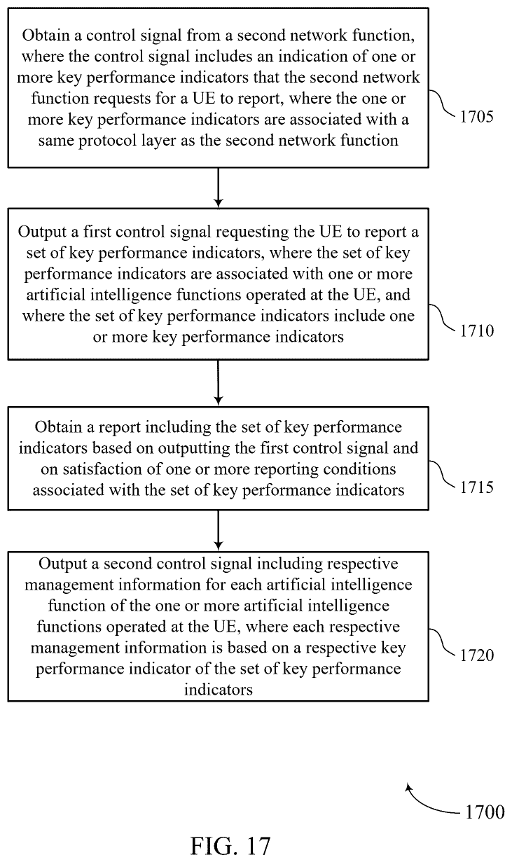

FIG. 17 shows a flowchart illustrating a method 1700 that supports signaling KPIs in wireless communications systems in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include obtaining a control signal from a second network function, where the control signal includes an indication of one or more KPIs that the second network function requests for a UE to report, where the one or more KPIs are associated with a same protocol layer as the second network function. The operations of 1705 may be performed in accordance with examples as disclosed herein. In some examples, aspects of the operations of 1705 may be performed by an KPI request manager 1225 as described with reference to FIG. 12.

At 1710, the method may include outputting a first control signal requesting the UE to report a set of KPIs, where the set of KPIs are associated with one or more AI or ML functions operated at the UE, and where the set of KPIs include the one or more KPIs. The operations of 1710 may be performed in accordance with examples as disclosed herein. In some examples, aspects of the operations of 1710 may be performed by an KPI request manager 1225 as described with reference to FIG. 12.

At 1715, the method may include obtaining a report including the set of KPIs based on outputting the first control signal and on satisfaction of one or more reporting conditions associated with the set of KPIs. The operations of 1715 may be performed in accordance with examples as disclosed herein. In some examples, aspects of the operations of 1715 may be performed by a monitoring report manager 1230 as described with reference to FIG. 12.

At 1720, the method may include outputting a second control signal including respective management information for each artificial intelligence function of the one or more AI or ML functions operated at the UE, where each respective management information is based on a respective KPI of the set of KPIs. The operations of 1720 may be performed in accordance with examples as disclosed herein. In some examples, aspects of the operations of 1720 may be performed by a AI or ML function manager 1235 as described with reference to FIG. 12.

The following provides an overview of aspects of the present disclosure:

Aspect 1: A method for wireless communications by a UE, comprising: receiving one or more first control signals requesting the UE to report a set of KPIs, wherein the set of KPIs are associated with one or more AI functions operated at the UE; determining the set of KPIs based at least in part on receiving the one or more first control signals; and transmitting one or more reports comprising the set of KPIs based at least in part on determining the set of KPIs and on satisfaction of one or more reporting conditions associated with the set of KPIs.

Aspect 2: The method of aspect 1, wherein receiving the one or more first control signals further comprises: receiving a respective control signal from a plurality of network functions, wherein each respective control signal requests the UE to report at least one KPI of the set of KPIs, and wherein each network function of the plurality of network functions is associated with a respective protocol layer of a plurality of protocol layers.

Aspect 3: The method of aspect 2, wherein transmitting the one or more reports further comprises: transmitting a respective report to each network function of the plurality of network functions, wherein each respective report comprises at least one KPI of the set of KPIs, and wherein each respective report corresponds to a same protocol layer as an associated network function of the plurality of network functions.

Aspect 4: The method of aspect 1, wherein receiving the one or more first control signals further comprises: receiving a single control signal from a first network function, wherein the single control signal requests the UE to report the set of KPIs, and wherein the first network function is associated with a first protocol layer of a plurality of protocol layers.

Aspect 5: The method of aspect 4, wherein transmitting the one or more reports further comprises: transmitting a single report comprising the set of KPIs, wherein each KPI of the set of KPIs is associated with a respective protocol layer of the plurality of protocol layers.

Aspect 6: The method of any of aspects 1 through 5, further comprising: transmitting one or more availability messages indicating that the set of KPIs have been determined, wherein transmitting the one or more reports is based at least in part on transmitting the one or more availability messages.

Aspect 7: The method of aspect 6, wherein transmitting the one or more availability messages further comprises: transmitting a respective availability message to each network function of a plurality of network functions, wherein each respective availability message indicates that at least one KPI of the set of KPIs has been determined, and wherein each network function of the plurality of network functions is associated with a respective protocol layer of a plurality of protocol layers.

Aspect 8: The method of aspect 6, wherein transmitting the one or more availability messages further comprises: transmitting a single availability message to a single network function, wherein the single availability message indicates that the set of KPIs have been determined, wherein each KPI of the set of KPIs is associated with a respective protocol layer of a plurality of protocol layers, and wherein the single network function is associated with a first protocol layer of the plurality of protocol layers.

Aspect 9: The method of any of aspects 6 through 8, wherein the one or more availability messages comprise UAI messages.

Aspect 10: The method of any of aspects 6 through 9, wherein transmitting the one or more availability messages is based at least in part on the satisfaction of the one or more reporting conditions associated with the set of KPIs.

Aspect 11: The method of any of aspects 1 through 10, further comprising: receiving one or more monitoring report requests indicating for the UE to transmit the one or more reports, wherein transmitting the one or more reports is based at least in part on receiving the one or more monitoring report requests.

Aspect 12: The method of aspect 11, wherein receiving the one or more monitoring report requests further comprises: receiving a respective monitoring report request from each network function of a plurality of network functions, wherein each respective monitoring report request indicates for the UE to transmit at least one KPI of the set of KPIs, and wherein each network function of the plurality of network functions is associated with a respective protocol layer of a plurality of protocol layers.

Aspect 13: The method of aspect 11, wherein receiving the one or more monitoring report requests further comprises: receiving a single monitoring report request from a single network function, wherein the single monitoring report request indicates for the UE to transmit the set of KPIs, wherein each KPI of the set of KPIs is associated with a respective protocol layer of a plurality of protocol layers, and wherein the single network function is associated with a first protocol layer of the plurality of protocol layers.

Aspect 14: The method of any of aspects 1 through 13, further comprising: receiving one or more second control signals comprising respective management information associated with each AI function of the one or more AI functions operated at the UE, wherein each respective management information is based at least in part on a respective KPI of the set of KPIs.

Aspect 15: The method of aspect 14, wherein receiving the one or more second control signals further comprises: receiving a respective second control signal from each network function of a plurality of network functions, wherein each respective second control signal comprises the respective management information for at least one AI function of the one or more AI functions, and wherein each network function of the plurality of network functions is associated with a respective protocol layer of a plurality of protocol layers.

Aspect 16: The method of aspect 14, wherein receiving the one or more second control signals further comprises: receiving single second control signal from a first network function, wherein the single second control signal comprises the respective management information associated with each AI function of the one or more AI functions operated at the UE, wherein each AI function of the one or more AI functions is associated with a respective protocol layer of a plurality of protocol layers, and wherein the first network function is associated with a first protocol layer of the plurality of protocol layers.

Aspect 17: The method of any of aspects 14 through 16, wherein the respective management information comprises reconfiguration information for a respective AI function of the one or more AI functions, one or more timers associated with operating the respective AI function, one or more counters associated with operating the respective AI function, an indication of whether the one respective AI function is activated or deactivated, an indication of performance metrics associated with the UE, or any combination thereof.

Aspect 18: The method of any of aspects 1 through 17, wherein the one or more reporting conditions comprise a quantity of duplicate data packets communicated at the UE satisfying a first threshold, a quantity of data packets received out of order at the UE satisfying a second threshold, a quantity of retransmitted data packets from the UE satisfying a third threshold, a quantity of discarded packets at the UE satisfying a fourth threshold, expiration of one or more timers associated with reporting the set of KPIs, one or more of the set of KPIs failing to satisfy a fifth threshold, a respective periodicity of each KPI of the set of KPIs, or any combination thereof.

Aspect 19: The method of any of aspects 1 through 18, wherein the one or more reports comprise MDT messages, and the one or more reports further comprise one or more measurement parameters associated with the one or more AI functions operated at the UE.

Aspect 20: The method of any of aspects 1 through 19, wherein the one or more reports comprise SON messages, and the one or more reports further comprise one or more measurement parameters associated with the one or more AI functions operated at the UE.

Aspect 21: A method for wireless communications by a first network function, comprising: outputting a first control signal requesting a UE to report a set of KPIs, wherein the set of KPIs are associated with one or more AI functions operated at the UE; obtaining a report comprising the set of KPIs based at least in part on outputting the first control signal and on satisfaction of one or more reporting conditions associated with the set of KPIs; and outputting a second control signal comprising respective management information for each AI function of the one or more AI functions operated at the UE, wherein each respective management information is based at least in part on a respective KPI of the set of KPIs.

Aspect 22: The method of aspect 21, further comprising: obtaining a third control signal from a second network function, wherein the third control signal comprises an indication of one or more KPIs that the second network function requests for the UE to report, wherein the one or more KPIs are associated with a same protocol layer as the second network function, and wherein the set of KPIs comprise the one or more KPIs.

Aspect 23: The method of aspect 22, further comprising: outputting a fourth control signal to the second network function, wherein the fourth control signal requests the second network function to provide the indication of the one or more KPIs, and wherein obtaining the third control signal is based at least in part on outputting the fourth control signal.

Aspect 24: The method of any of aspects 21 through 23, further comprising: outputting a third control signal to a second network function based at least in part on obtaining the report, wherein the third control signal comprises one or more KPIs of the set of KPIs that are associated with a same protocol layer as the second network function.

Aspect 25: The method of aspect 24, further comprising: obtaining a fourth control signal from the second network function based at least in part on outputting the third control signal, wherein the fourth control signal comprises management information associated with the one or more KPIs, and wherein transmitting the second control signal is based at least in part on obtaining the fourth control signal.

Aspect 26: The method of any of aspects 21 through 25, wherein each respective management information comprises reconfiguration information for a respective AI function, one or more timers associated with operating the respective AI function, one or more counters associated with operating the respective AI function, an indication of whether the respective AI function is activated or deactivated, an indication of performance metrics associated with the UE, or any combination thereof.

Aspect 27: The method of any of aspects 21 through 26, wherein the report comprises a MDT message, and the report further comprises one or more measurement parameters associated with the one or more AI functions operated at the UE.

Aspect 28: The method of any of aspects 21 through 27, wherein the report comprises a SON message, and the report further comprise one or more measurement parameters associated with the one or more AI functions operated at the UE.

Aspect 29: A UE for wireless communications, comprising one or more memories storing processor-executable code, and one or more processors coupled with the one or more memories and individually or collectively operable to execute the code to cause the UE to perform a method of any of aspects 1 through 20.

Aspect 30: A UE for wireless communications, comprising at least one means for performing a method of any of aspects 1 through 20.

Aspect 31: A non-transitory computer-readable medium storing code for wireless communications, the code comprising instructions executable by one or more processors to perform a method of any of aspects 1 through 20.

Aspect 32: A first network function for wireless communications, comprising one or more memories storing processor-executable code, and one or more processors coupled with the one or more memories and individually or collectively operable to execute the code to cause the first network function to perform a method of any of aspects 21 through 28.

Aspect 33: A first network function for wireless communications, comprising at least one means for performing a method of any of aspects 21 through 28.

Aspect 34: A non-transitory computer-readable medium storing code for wireless communications, the code comprising instructions executable by one or more processors to perform a method of any of aspects 21 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more first control signals requesting the UE to report a set of key performance indicators, wherein the set of key performance indicators are associated with one or more artificial intelligence functions operated at the UE;
determine the set of key performance indicators based at least in part on receiving the one or more first control signals; and
transmit one or more reports comprising the set of key performance indicators based at least in part on determining the set of key performance indicators and on satisfaction of one or more reporting conditions associated with the set of key performance indicators.

2. The UE of claim 1, wherein, to receive the one or more first control signals, the one or more processors are individually or collectively further operable to execute the code to cause the UE to:
receive a respective control signal from a plurality of network functions, wherein each respective control signal requests the UE to report at least one key performance indicator of the set of key performance indicators, and wherein each network function of the plurality of network functions is associated with a respective protocol layer of a plurality of protocol layers.

3. The UE of claim 2, wherein, to transmit the one or more reports, the one or more processors are individually or collectively further operable to execute the code to cause the UE to:
transmit a respective report to each network function of the plurality of network functions, wherein each respective report comprises the at least one key performance indicator of the set of key performance indicators, and wherein each respective report corresponds to a same protocol layer as an associated network function of the plurality of network functions.

4. The UE of claim 1, wherein, to receive the one or more first control signals, the one or more processors are individually or collectively further operable to execute the code to cause the UE to:
receive a single control signal from a first network function, wherein the single control signal requests the UE to report the set of key performance indicators, and wherein the first network function is associated with a first protocol layer of a plurality of protocol layers.

5. The UE of claim 4, wherein, to transmit the one or more reports, the one or more processors are individually or collectively further operable to execute the code to cause the UE to:
transmit a single report comprising the set of key performance indicators, wherein each key performance indicator of the set of key performance indicators is associated with a respective protocol layer of the plurality of protocol layers.

6. The UE of claim 1, wherein the one or more processors are individually or collectively further operable to execute the code to cause the UE to:
transmit one or more availability messages indicating that the set of key performance indicators have been determined, wherein transmitting the one or more reports is based at least in part on transmitting the one or more availability messages.

7. The UE of claim 6, wherein, to transmit the one or more availability messages, the one or more processors are individually or collectively further operable to execute the code to cause the UE to:
transmit a respective availability message to each network function of a plurality of network functions, wherein each respective availability message indicates that at least one key performance indicator of the set of key performance indicators has been determined, and wherein each network function of the plurality of network functions is associated with a respective protocol layer of a plurality of protocol layers.

8. The UE of claim 6, wherein, to transmit the one or more availability messages, the one or more processors are individually or collectively further operable to execute the code to cause the UE to:
transmit a single availability message to a single network function, wherein the single availability message indicates that the set of key performance indicators have been determined, wherein each key performance indicator of the set of key performance indicators is associated with a respective protocol layer of a plurality of protocol layers, and wherein the single network function is associated with a first protocol layer of the plurality of protocol layers.

9. The UE of claim 6, wherein the one or more availability messages comprise UE assistance information messages.

10. The UE of claim 6, wherein transmitting the one or more availability messages is based at least in part on the satisfaction of the one or more reporting conditions associated with the set of key performance indicators.

11. The UE of claim 1, wherein the one or more processors are individually or collectively further operable to execute the code to cause the UE to:
receive one or more monitoring report requests indicating for the UE to transmit the one or more reports, wherein transmitting the one or more reports is based at least in part on receiving the one or more monitoring report requests.

12. The UE of claim 11, wherein, to receive the one or more monitoring report requests, the one or more processors are individually or collectively further operable to execute the code to cause the UE to:
receive a respective monitoring report request from each network function of a plurality of network functions, wherein each respective monitoring report request indicates for the UE to transmit at least one key performance indicator of the set of key performance indicators, and wherein each network function of the plurality of network functions is associated with a respective protocol layer of a plurality of protocol layers.

13. The UE of claim 11, wherein, to receive the one or more monitoring report requests, the one or more processors are individually or collectively further operable to execute the code to cause the UE to:
receive a single monitoring report request from a single network function, wherein the single monitoring report request indicates for the UE to transmit the set of key performance indicators, wherein each key performance indicator of the set of key performance indicators is associated with a respective protocol layer of a plurality of protocol layers, and wherein the single network function is associated with a first protocol layer of the plurality of protocol layers.

14. The UE of claim 1, wherein the one or more processors are individually or collectively further operable to execute the code to cause the UE to:
receive one or more second control signals comprising respective management information associated with each artificial intelligence function of the one or more artificial intelligence functions operated at the UE, wherein each respective management information is based at least in part on a respective key performance indicator of the set of key performance indicators.

15. The UE of claim 14, wherein, to receive the one or more second control signals, the one or more processors are individually or collectively further operable to execute the code to cause the UE to:
receive a respective second control signal from each network function of a plurality of network functions, wherein each respective second control signal comprises the respective management information for at least one artificial intelligence function of the one or more artificial intelligence functions, and wherein each network function of the plurality of network functions is associated with a respective protocol layer of a plurality of protocol layers.

16. The UE of claim 14, wherein, to receive the one or more second control signals, the one or more processors are individually or collectively further operable to execute the code to cause the UE to:
receive single second control signal from a first network function, wherein the single second control signal comprises the respective management information associated with each artificial intelligence function of the one or more artificial intelligence functions operated at the UE, wherein each artificial intelligence function of the one or more artificial intelligence functions is associated with a respective protocol layer of a plurality of protocol layers, and wherein the first network function is associated with a first protocol layer of the plurality of protocol layers.

17. The UE of claim 14, wherein the respective management information comprises reconfiguration information for a respective artificial intelligence function of the one or more artificial intelligence functions, one or more timers associated with operating the respective artificial intelligence function, one or more counters associated with operating the respective artificial intelligence function, an indication of whether the one respective artificial intelligence function is activated or deactivated, an indication of performance metrics associated with the UE, or any combination thereof.

18. The UE of claim 1, wherein the one or more reporting conditions comprise a quantity of duplicate data packets communicated at the UE satisfying a first threshold, a quantity of data packets received out of order at the UE satisfying a second threshold, a quantity of retransmitted data packets from the UE satisfying a third threshold, a quantity of discarded packets at the UE satisfying a fourth threshold, expiration of one or more timers associated with reporting the set of key performance indicators, one or more of the set of key performance indicators failing to satisfy a fifth threshold, a respective periodicity of each key performance indicator of the set of key performance indicators, or any combination thereof.

19. The UE of claim 1, wherein the one or more reports comprise minimization of drive test (MDT) message, and the one or more reports further comprise one or more measurement parameters associated with the one or more artificial intelligence functions operated at the UE.

20. The UE of claim 1, wherein the one or more reports comprise self-organizing network (SON) messages, and the one or more reports further comprise one or more measurement parameters associated with the one or more artificial intelligence functions operated at the UE.

21. A first network function, comprising:
one or more memories storing processor-executable code; and
one or more processors coupled with the one or more memories and individually or collectively operable to execute the code to cause the first network function to:
output a first control signal requesting a user equipment (UE) to report a set of key performance indicators, wherein the set of key performance indicators are associated with one or more artificial intelligence functions operated at the UE;
obtain a report comprising the set of key performance indicators based at least in part on outputting the first control signal and on satisfaction of one or more reporting conditions associated with the set of key performance indicators; and
output a second control signal comprising respective management information for each artificial intelligence function of the one or more artificial intelligence functions operated at the UE, wherein each respective management information is based at least in part on a respective key performance indicator of the set of key performance indicators.

22. The first network function of claim 21, wherein the one or more processors are individually or collectively further operable to execute the code to cause the first network function to:
obtain a third control signal from a second network function, wherein the third control signal comprises an indication of one or more key performance indicators that the second network function requests for the UE to report, wherein the one or more key performance indicators are associated with a same protocol layer as the second network function, and wherein the set of key performance indicators comprise the one or more key performance indicators.

23. The first network function of claim 22, wherein the one or more processors are individually or collectively further operable to execute the code to cause the first network function to:
output a fourth control signal to the second network function, wherein the fourth control signal requests the second network function to provide the indication of the one or more key performance indicators, and wherein obtaining the third control signal is based at least in part on outputting the fourth control signal.

24. The first network function of claim 21, wherein the one or more processors are individually or collectively further operable to execute the code to cause the first network function to:
output a third control signal to a second network function based at least in part on obtaining the report, wherein the third control signal comprises one or more key performance indicators of the set of key performance indicators that are associated with a same protocol layer as the second network function.

25. The first network function of claim 24, wherein the one or more processors are individually or collectively further operable to execute the code to cause the first network function to:
obtain a fourth control signal from the second network function based at least in part on outputting the third control signal, wherein the fourth control signal comprises management information associated with the one or more key performance indicators, and wherein transmitting the second control signal is based at least in part on obtaining the fourth control signal.

26. The first network function of claim 21, wherein each respective management information comprises reconfiguration information for a respective artificial intelligence function, one or more timers associated with operating the respective artificial intelligence function, one or more counters associated with operating the respective artificial intelligence function, an indication of whether the respective artificial intelligence function is activated or deactivated, an indication of performance metrics associated with the UE, or any combination thereof.

27. The first network function of claim 21, wherein:
the report comprises a minimization of drive test (MDT) messages, and
the report further comprises one or more measurement parameters associated with the one or more artificial intelligence functions operated at the UE.

28. The first network function of claim 21, wherein:
the report comprises a self-organizing network (SON) message, and
the report further comprise one or more measurement parameters associated with the one or more artificial intelligence functions operated at the UE.

29. A method for wireless communications by a user equipment (UE), comprising:
receiving one or more first control signals requesting the UE to report a set of key performance indicators, wherein the set of key performance indicators are associated with one or more artificial intelligence functions operated at the UE;
determining the set of key performance indicators based at least in part on receiving the one or more first control signals; and
transmitting one or more reports comprising the set of key performance indicators based at least in part on determining the set of key performance indicators and on satisfaction of one or more reporting conditions associated with the set of key performance indicators.

30. A method for wireless communications by a first network function, comprising:
outputting a first control signal requesting a user equipment (UE) to report a set of key performance indicators, wherein the set of key performance indicators are associated with one or more artificial intelligence functions operated at the UE;
obtaining a report comprising the set of key performance indicators based at least in part on outputting the first control signal and on satisfaction of one or more reporting conditions associated with the set of key performance indicators; and
outputting a second control signal comprising respective management information for each artificial intelligence function of the one or more artificial intelligence functions operated at the UE, wherein each respective management information is based at least in part on a respective key performance indicator of the set of key performance indicators.
